(19) United States
(12) Patent Application Publication
(10) Pub. No.: US 2025/0287911 A1
(43) Pub. Date: Sep. 18, 2025

(54) PORTABLE WINDBREAK

(71) Applicant: Rawhide Portable Corral, Inc., Abilene, KS (US)

(72) Inventor: John L. McDonald, Abilene, KS (US)

(21) Appl. No.: 18/911,819

(22) Filed: Oct. 10, 2024

Related U.S. Application Data
(60) Provisional application No. 63/564,306, filed on Mar. 12, 2024.

(51) Int. Cl. A01K 3/00; B62D 63/06; B62D 63/08

(52) U.S. Cl. CPC A01K 3/001; B62D 63/062; B62D 63/08

(57) ABSTRACT

A portable windbreak may be operably attached to a vehicle for advancement in a forward direction. The portable windbreak includes a wheeled chassis and a set of panels. The wheeled chassis includes an elongated frame and a ground-engaging transport wheel operable to support the frame above ground, with the frame extending longitudinally along the forward direction to at least partly define a storage area. The set of panels is removably supported by the frame and extends longitudinally along the frame in a stored condition. The set of panels is shiftable between the stored condition and a deployed condition, in which one or more panels of the set extend outside of the storage area to form a windbreak wall.

### CROSS-REFERENCE TO RELATED APPLICATIONS

This application claims the priority benefit of U.S. Provisional Application Ser. No. 63/564,306, filed Mar. 12, 2022, entitled PORTABLE WINDBREAK, which is hereby incorporated in its entirety by reference herein.

### BACKGROUND

### 1. FIELD

The present disclosure relates generally to the field of windbreaks. More specifically, the aspects of the disclosure relate to a portable windbreak.

### 2. DESCRIPTION OF RELATED ART

It is known by ranchers and livestock owners to shelter livestock from the weather. When livestock are kept in fields or pastures with little or no trees, a conventional windbreak may be installed to provide an artificial shelter. Prior art windbreaks may include fencing and posts that are either permanently or temporarily installed to shelter livestock (such as cattle or horses). Known windbreaks may be deployed to restrict livestock from being exposed to various weather elements, such as wind, rain, and snow.

However, conventional windbreaks have certain deficiencies. For instance, prior art windbreaks are time consuming to construct and install. It is also labor intensive to erect or take down known windbreaks. Once erected, conventional windbreaks are difficult to move from one location to another location, whether the locations are in different fields or even in the same field. At the same time, it is common for known windbreaks to be readily blown over and/or damaged by persistent exposure to sustained winds.

### SUMMARY

The following brief summary is provided to indicate the nature of the subject matter disclosed herein. While certain aspects of the present disclosure are described below, the summary is not intended to limit the scope of the present invention.

Embodiments of the present disclosure provide a portable windbreak that does not suffer from the problems and limitations of the prior art windbreaks, including those set forth above.

An aspect of the present disclosure concerns a portable windbreak configured to be attached to a vehicle for advancement in a forward direction. The portable windbreak includes a wheeled chassis and a set of panels. The wheeled chassis includes an elongated frame and a ground-engaging transport wheel operable to support the frame above ground, with the frame extending longitudinally along the forward direction to at least partly define a storage area. The set of panels is removably supported by the frame and extends longitudinally along the frame in a stored condition, with the frame configured to support the set of panels in the stored condition while the portable windbreak is advanced in the forward direction by the vehicle. The set of panels is shiftable between the stored condition, in which the set of panels is supported within the storage area by the wheeled chassis for transport therewith, and a deployed condition, in which one or more panels of the set extend outside of the storage area to form a windbreak wall.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWINGS

Illustrative embodiments of the present disclosure are described in detail below with reference to the attached drawing figures and wherein:

FIG. 1 is a perspective view of a portable windbreak, according to some aspects of the disclosure;

FIG. 2 is a perspective view of the portable windbreak similar to FIG. 1, but taken from the opposite side, showing the portable windbreak in a deployed condition in which opposite sets of panels are unfolded and opposite shelters are unfolded;

FIG. 3 is a perspective view of the portable windbreak shown in FIGS. 1 and 2, showing the portable windbreak in a stored condition in which the opposite sets of panels are folded and the opposite shelters are folded;

FIG. 4 is a fragmentary perspective view of the portable windbreak shown in FIGS. 1-3, showing the shelters and sets of panels removed to depict a wheeled chassis;

FIG. 5 is a fragmentary perspective view of the portable windbreak shown in FIGS. 1-3, showing the set of panels on the left side of the wheeled chassis removed, with a roof of the shelter on the left side of the wheeled chassis also removed to depict upright walls of the left side shelter;

FIG. 6 is a fragmentary perspective view of one set of panels shown in FIGS. 1-3, showing an endmost panel pivotally attached to an adjacent panel;

FIG. 7 is an end view of one of the panels shown in FIGS. 1-3, showing a brace unfolded from the panel to engage the ground;

FIG. 8 is a fragmentary perspective view of the portable windbreak shown in FIGS. 1-3, showing the shelters unfolded into the deployed condition;

FIG. 9 is a fragmentary perspective view of the wheeled chassis and shelters shown in FIGS. 1-3, with sheet sections being removed from the upright walls and roofs of the shelters;

FIG. 10 is a perspective view of the wheeled chassis and shelters similar to FIG. 9, but showing the sheet sections associated with the upright walls and roofs;

FIG. 11 is a perspective view of the wheeled chassis and shelters similar to FIG. 10, but taken from the opposite side;

FIG. 12 is a rear elevational view of the portable windbreak shown in FIGS. 1-11, showing the portable windbreak in the deployed condition;

FIG. 13 is an enlarged fragmentary perspective view of the wheeled chassis and shelters shown in FIGS. 1-12, depicting roofs pivotally attached to the wheeled chassis;

FIG. 14 is a fragmentary perspective view of the wheeled chassis and shelters shown in FIGS. 1-13, depicting a hydraulic cylinder that shiftably supports a roof relative to the wheeled chassis;

FIG. 15 is a top plan view of the portable windbreak shown in FIGS. 1-12, showing the portable windbreak in the stored condition;

FIG. 16 is a front perspective view of the portable windbreak shown in FIGS. 1-12 and 15, showing the portable windbreak in the stored condition;

FIG. 17 is an upper perspective view of a second embodiment of a portable windbreak, according to some aspects of the disclosure;

FIG. 18 is a fragmentary upper perspective view of the portable windbreak shown in FIG. 17, showing the portable windbreak in a deployed condition in which opposite sets of panels are unfolded and opposite shelters are unfolded;

FIG. 19 is an enlarged lower perspective view of the portable windbreak similar to FIG. 18, but taken from underneath the portable windbreak;

FIG. 20 is a rear perspective view of the portable windbreak shown in FIGS. 17-19, showing the portable windbreak in a stored condition in which the opposite sets of panels are folded and the opposite shelters are folded;

FIG. 21 is a front perspective view of the portable windbreak similar to FIG. 20, but taken from underneath the portable windbreak;

FIG. 22 is a fragmentary perspective view of one set of panels shown in FIGS. 17-21, showing a panel with a shiftable panel brace and an anchor to secure the panel brace to the ground;

FIG. 23 is a fragmentary perspective view of the panel similar to FIG. 22, but showing the panel from an opposite side;

FIG. 24 is an upper perspective view of a third embodiment of a portable windbreak, according to some aspects of the disclosure;

FIG. 25 is a fragmentary upper perspective view of the portable windbreak shown in FIG. 24, showing the portable windbreak in a deployed condition in which opposite sets of panels are unfolded and opposite shelters are unfolded;

FIG. 26 is an upper perspective view of the portable windbreak similar to FIG. 25, but showing the sets of panels folded and stored on a wheeled chassis of the portable windbreak;

FIG. 27 is a fragmentary upper perspective view of the portable windbreak shown in FIGS. 24-26, showing a wheeled chassis having a spine and forward and aft sections interconnected by the spine;

FIG. 28 is a side elevational view of the wheeled chassis shown in FIGS. 24-27;

FIG. 29 is a fragmentary upper perspective view of the portable windbreak similar to FIG. 27, but also showing sets of panels folded and stored on the wheeled chassis;

FIG. 30 is a rear perspective view of the portable windbreak similar to FIG. 25, but taken from underneath the portable windbreak;

FIG. 31 is a front elevational view of the portable windbreak shown in FIGS. 24-30, showing the portable windbreak in the deployed condition;

FIG. 32 is a rear elevational view of the portable windbreak similar to FIG. 31, but taken from the opposite side of the portable windbreak;

FIG. 33 is a rear perspective view of the portable windbreak shown in FIGS. 24-32, showing the portable windbreak in a stored condition in which the opposite sets of panels and the opposite shelters are folded and stored on the wheeled chassis;

FIG. 34 is a fragmentary perspective view of one set of panels shown in FIGS. 24-26 and 29-33, showing a panel with a shiftable panel brace and an anchor to secure the panel brace to the ground;

FIG. 35A is a fragmentary perspective view of the shiftable panel brace and the anchor shown in FIG. 34, depicting a chain that attaches the shiftable panel brace to the anchor;

FIG. 35B is a fragmentary perspective view of the shiftable panel brace, the anchor, and chain similar to FIG. 35A, but taken from the opposite side of the shiftable panel brace;

FIG. 36A is a fragmentary perspective view of the panel and shiftable panel brace shown in FIG. 34, depicting a pivot assembly to shiftably attach the panel brace to the panel; and

FIG. 36B is a fragmentary perspective view of the panel and shiftable panel brace similar to FIG. 36A, but taken from the opposite side of the panel.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the disclosure are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

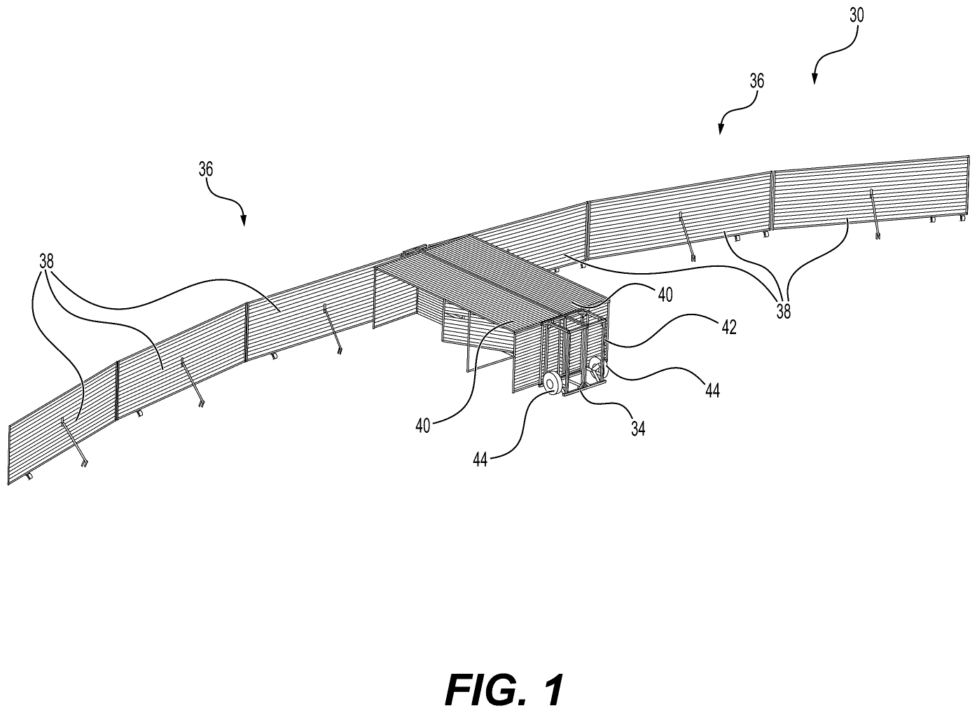

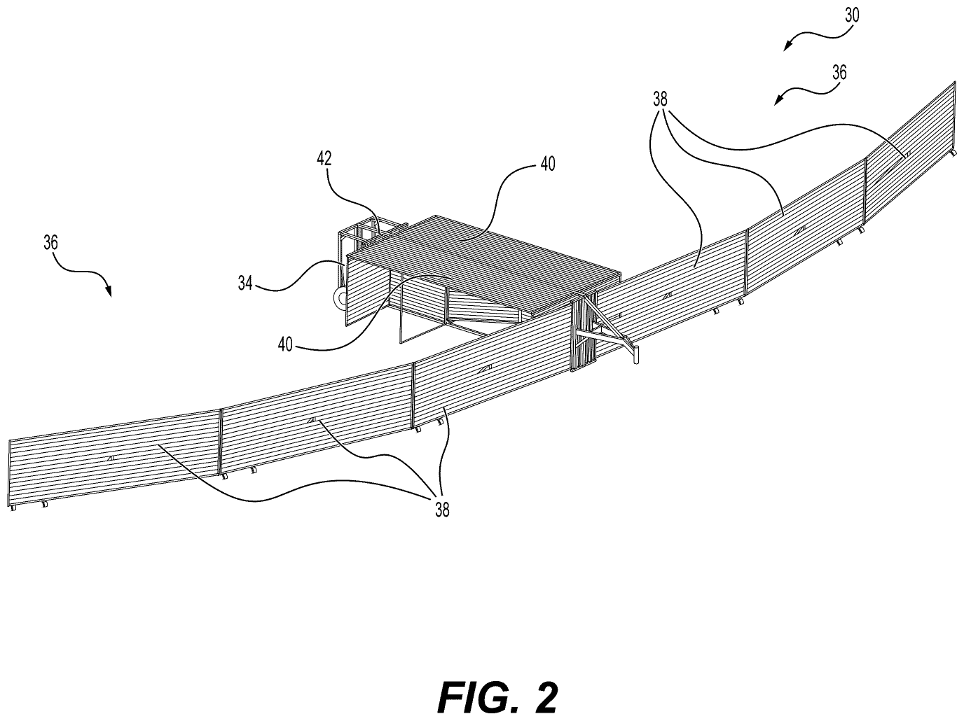

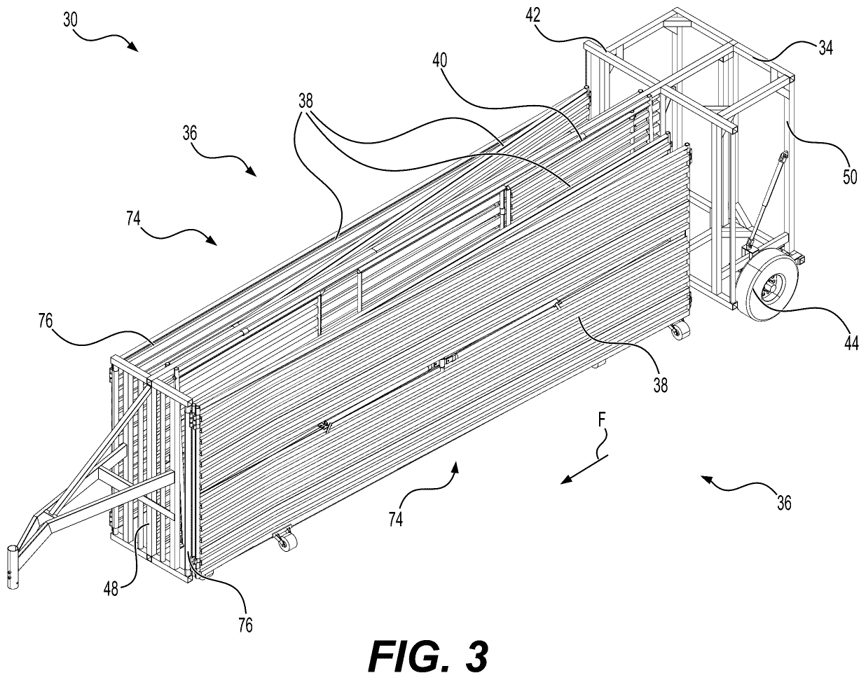

Turning initially to FIGS. 1-3, a portable windbreak 30 may be selectively deployed to provide a shelter. For example, in various embodiments, portable windbreak 30 may be configured for sheltering livestock (such as cattle or horses), people, or other items. Portable windbreak 30 is operable to be shifted between a deployed condition (see FIGS. 1 and 2) and a stored condition (see FIG. 3). In the usual manner, portable windbreak 30 may be deployed to restrict livestock, people, or other items from being exposed to various weather elements, such as wind, rain, and snow.

Portable windbreak 30 is also configured to be attached to a powered vehicle (not shown) for transportation. In the usual manner, portable windbreak 30 may be attached behind a powered vehicle, such as a truck, primarily for advancement in a forward direction F so that the portable windbreak 30 may be transported from one location to another.

The portable windbreak 30 may include a wheeled chassis 34, opposed sets 36 of panels 38, and collapsible shelters 40. As explained below, wheeled chassis 34 is operable to support the opposed sets 36 of panels 38 and the shelters 40 during use, particularly during transportation of the portable windbreak 30.

In the illustrated embodiment, wheeled chassis 34 may include an elongated frame 42 and ground-engaging transport wheels 44. Transport wheels 44 may be independently shiftable relative to the frame 42 and operable to support the frame 42 above ground.

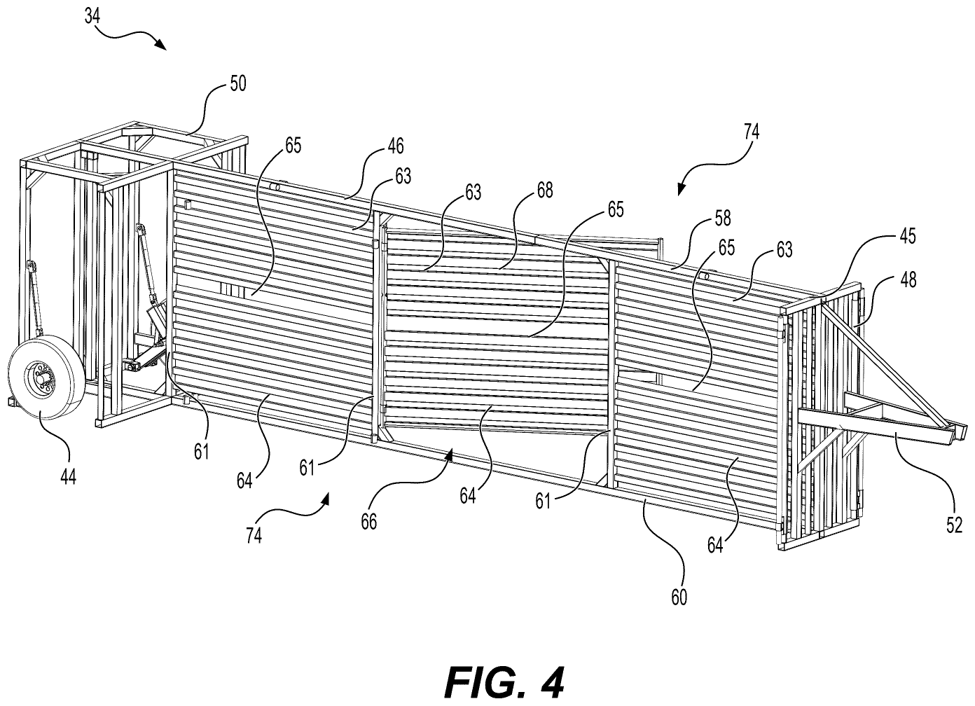

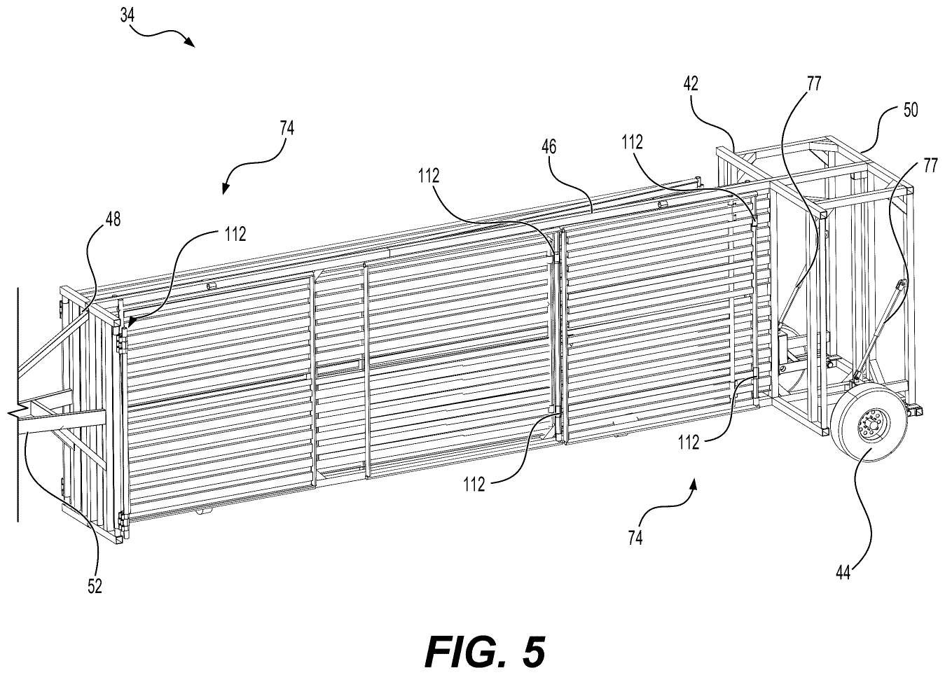

Turning to FIGS. 4 and 5, the depicted frame 42 preferably includes a spine 46 and spaced apart forward and aft sections 48,50 connected by the spine 46. Frame also includes a tongue 52 attached to and extending forwardly of the forward section 48. In the usual manner, tongue 52 has a hitch configured to be removably attached to the powered vehicle so that the vehicle may tow the windbreak 30 from one location to another.

Spine 46 extends longitudinally along the forward direction. The spine 46 preferably comprises a wall with upper and lower tubular beams 58 and 60 and tubular uprights 61 welded to form a monolithic and rigid weldment (see FIG. 4). Tubular beams 58 and 60 and tubular uprights 61 preferably comprise tubular members. The spine 46 may also include a swingable gate, as will be described. Spine 46 may further include upper sheet sections 63 and lower sheet sections 64 (see FIG. 4) that restrict air flow (such as wind flow) from passing from one side of the spine 46 to the other side of the spine 46. It will also be understood that upper and lower sheet sections 63 and 64 may restrict other weather (such as rain and show) from passing through the spine 46.

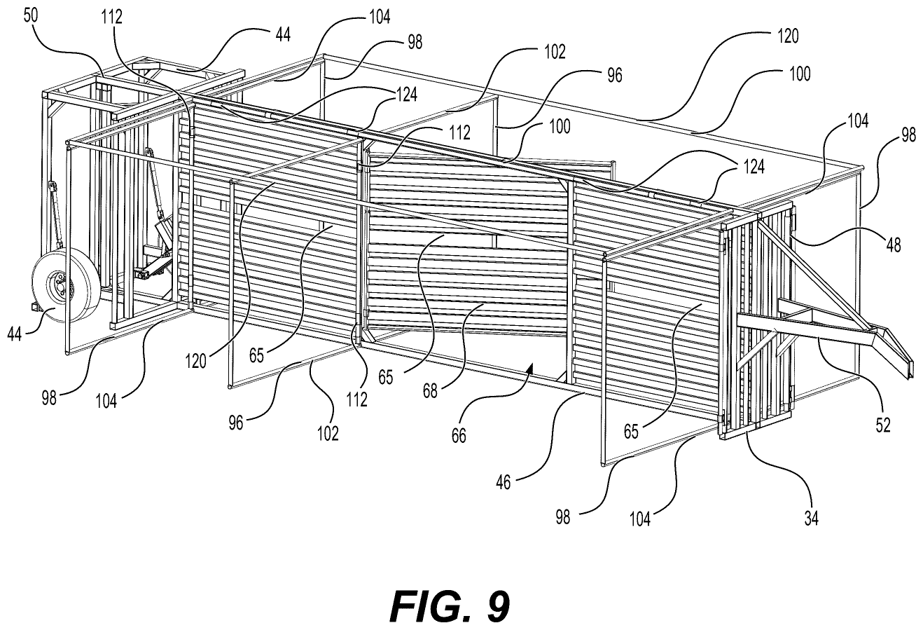

The sheet sections 63 and 64 may span adjacent uprights 61 (see FIG. 4). Sheet sections 63 and 64 may each include a solid material sheet that at least partly covers an opening between adjacent uprights 61. Each pair of adjacent upper and lower sheet sections 63 and 64 may be spaced apart to cooperatively define a relief opening 65 (see FIG. 9) that permits limited air flow (such as wind flow) to pass between the sheet sections 63 and 64 and through the spine 46.

Spine 46 may also present an opening 66 (see FIG. 4) that permits users and livestock to move from one side of the spine 46 to the other side of the spine 46. Opening 66 may be selectively opened and closed by swingable gate 68, which is configured to be swung between an open position (e.g., see FIG. 4) and a closed position. Gate 68 may also include upper and lower sheet sections 63 and 64 that are spaced apart to define a relief opening 65 (see FIG. 9).

Forward and aft sections 48,50 also preferably comprise tubular members fixed relative to one another to form a rigid weldment. The forward and aft sections 48,50 cooperate with the spine 46 to define opposed storage areas 74 (see FIG. 3) configured to receive corresponding panels 38. The illustrated transport wheels 44 are associated with the aft section 50 and spaced rearwardly of the storage areas 74.

The forward and aft sections 48,50 each extend outboard of the spine 46 in opposite lateral directions so that the spine 46 and the forward and aft sections 48,50 cooperatively define the opposed storage areas 74. Furthermore, the forward section 48 includes opposite outboard margins 76 (see FIG. 3) to which the sets 36 of panels 38 are pivotally attached. It is also within the scope of certain aspects of the present invention for one or both of the forward and aft sections to be alternatively configured. For at least some aspects of the present invention, the frame may include one or more alternative storage areas to receive panels. For instance, a storage area may be alternatively defined by one or more components of the frame.

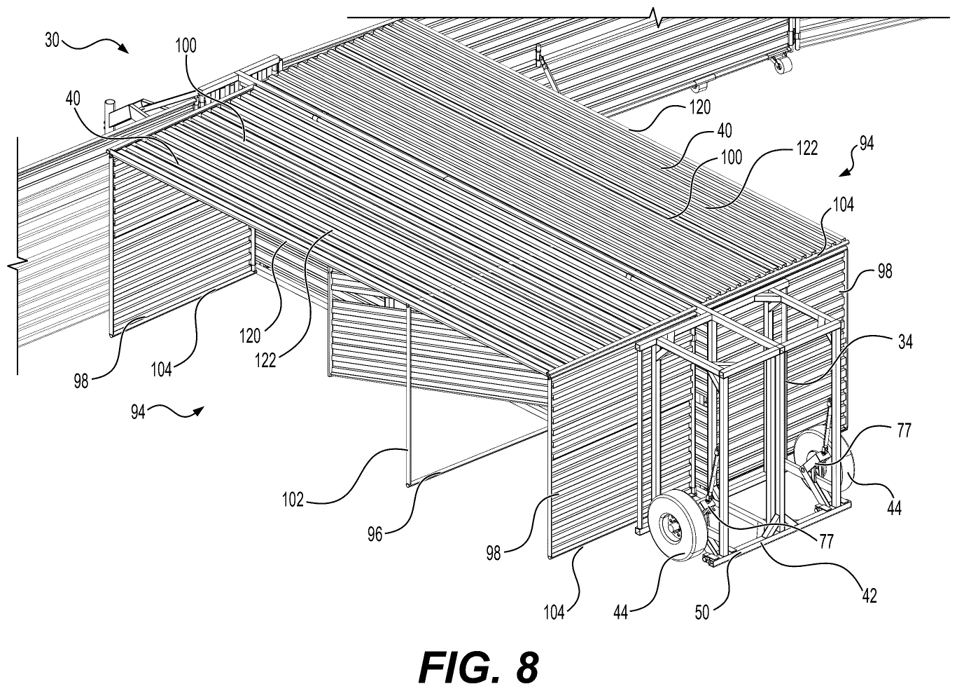

The wheeled chassis 34 may further include two suspensions 77 (see FIGS. 5 and 8) and spindles (not shown) supported by the suspensions 77. In the usual manner, spindles rotatably receive the transport wheels 44. The suspension 77 is configured to shiftably support the spindles and transport wheels 44 relative to the frame 42. Additional preferred details of the suspension 77, as well as other suspension embodiments, are disclosed by U.S. Pat. No. 11,793,158, entitled PORTABLE CORRAL SUSPENSION WITH TORSION AXLE, which is hereby incorporated in its entirety by reference herein.

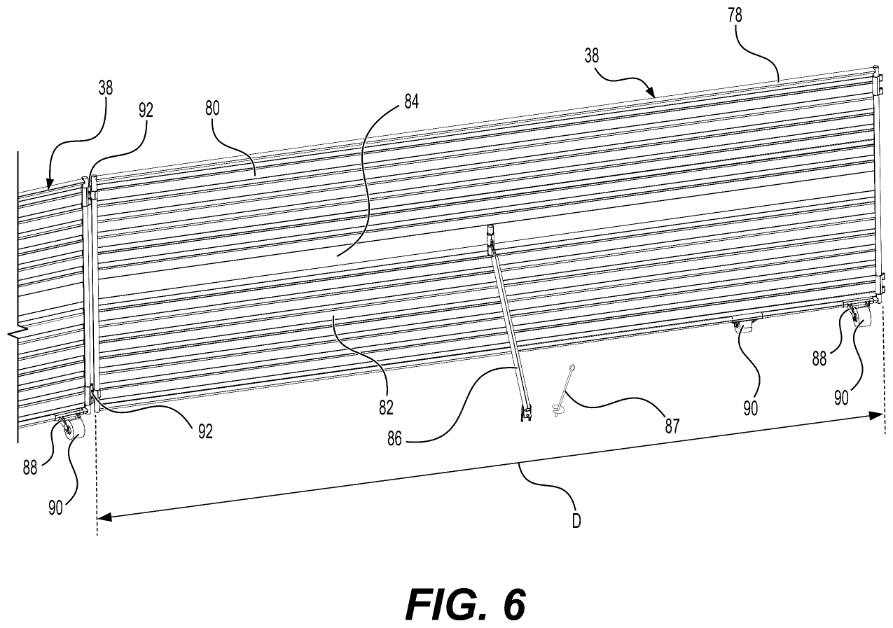

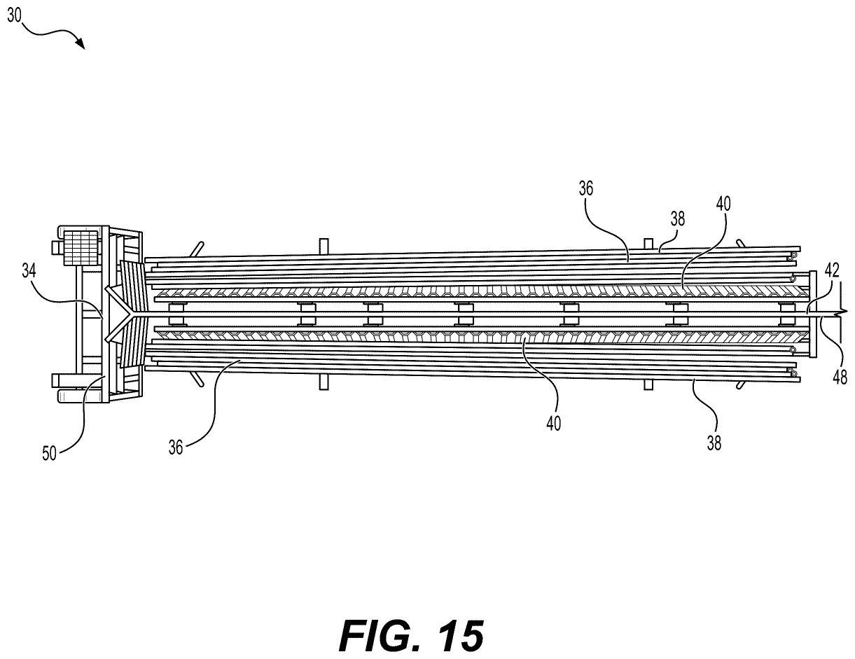

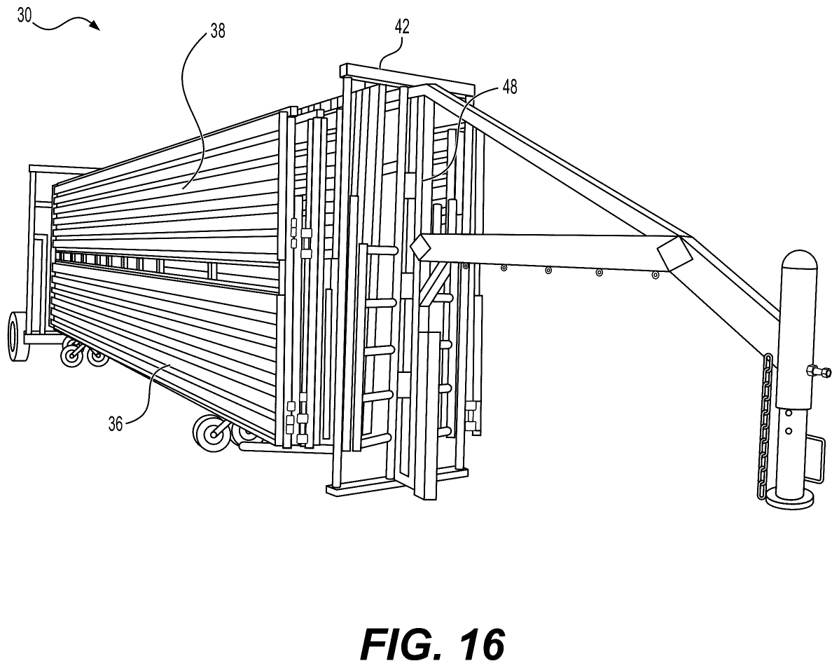

Turning to FIGS. 1, 2, and 6, panels 38 may be unfolded (e.g., into the deployed condition) relative to the wheeled chassis 34. Panels 38 may be folded (e.g., into the stored condition) for storage and transport with the wheeled chassis 34 (see FIGS. 3, 15, and 16). Each panel 38 may include a frame 78, an upper sheet section 80, and a lower sheet section 82 (see FIG. 6).

The upper and lower sheet sections 80 and 82 may span the length of the panel 38 (see FIG. 6). Sheet sections 80 and 82 may each include a solid material sheet that at least partly covers an opening defined by the frame 78. Each pair of adjacent upper and lower sheet sections 80 and 82 may be spaced apart to define a relief opening 84 that permits limited air flow (such as wind flow) through the panel 38.

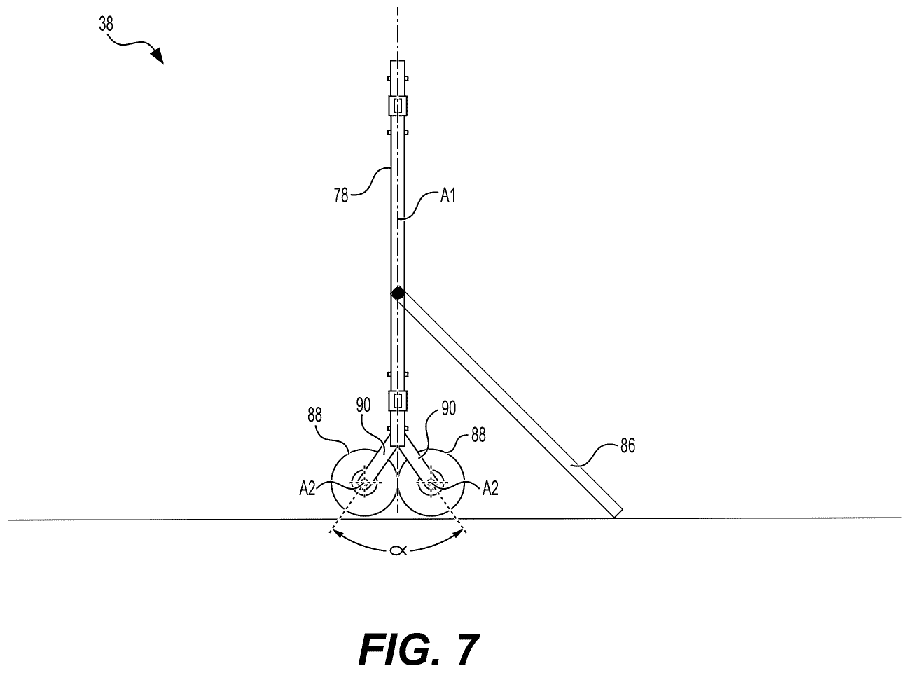

Each panel 38 may also include a shiftable brace 86. The brace 86 may be shiftable into and out of a deployed position (see FIGS. 6 and 7) in which the brace 86 extends downwardly from the frame 78 to engage the ground. Brace 86 may also be shiftable into and out of a stored position (not shown) in which the brace 86 is supported by the frame 78 in a location spaced above the ground. A ground-engaging end of the brace 86 may be removably secured to the ground via an anchor 87 (see FIG. 6).

Each panel 38 may further include a pair of panel wheels 88 and wheel brackets 90 that depend from the frame 78 to rotatably support the panel wheels 88. The pair of panel wheels 88 are configured to support the frame 78 above the ground and roll across the ground to permit swinging movement of the wheeled panel.

The frame 78 defines an upright panel axis A1 (see FIG. 7). Panel wheels 88 each define a panel wheel axis A2, with the panel wheels 88 being axially offset from the upright panel axis Al to opposite sides of the respective panel 38.

Wheel brackets 90 may cooperatively define an oblique offset angle α therebetween (see FIG. 7). The offset angle α preferably ranges from about forty-five degrees (45°) to about ninety degrees (90°).

Each set 36 of panels 38 preferably includes a series of panels 38 pivotally attached to one another in series (see FIGS. 1 and 2). Panels 38 are preferably configured to be folded (see FIGS. 3, 15, and 16) into and out of at least partial registration with one another. Panels 38 may also be unfolded (see FIGS. 1 and 2) to restrict airflow in covered areas 94 extending along opposite sides of each set 36 of panels 38.

The panels 38 may each define a panel length dimension D (see FIG. 6) that is preferably at least about eighteen feet (18′). In one or more embodiments, panel length dimension D may range from about eighteen feet (18′) to about twenty-four feet (24′). It is also within the ambit of certain aspects of the present invention for the panel length of one or more panels to fall outside of the above-listed range.

Adjacent pairs of panels 38 may each be pivotally attached to one another by panel pivot joints 92 (see FIG. 6) that permit relative swinging movement between the adjacent panels 38. Additional preferred details of the panel pivot joint are disclosed by U.S. Publication No. 2008/0296548, entitled PANEL CONNECTION SYSTEM, which is hereby incorporated in its entirety by reference herein. However, it is within the scope of at least certain aspects of the present invention for one or more pairs of adjacent panels to be alternatively shiftably attached relative to one another.

The opposed sets 36 of panels 38 each present a plurality of panels 38 on respective sides of the spine 46. Each such plurality of panels 38, which are stacked to one side of the spine 46 in the stored condition, may include three (3) panels 38, although the set 36 may include more panels or fewer panels.

In alternative embodiments, it will be appreciated that one or both of the sets may have an alternative number of panels. Although the inboard and outboard sets may include the same number of panels, the sets may have different numbers of panels within the ambit of the present invention. For at least certain aspects of the present invention, the windbreak may have only a single set of panels on one side of the frame. For certain aspects of the present invention, windbreak may be devoid of any sets 36 of panels 38 (e.g., where the windbreak includes the wheeled chassis and shelters without any sets of panels).

The sets 36 of panels 38 are positioned to extend longitudinally along respective sides of the spine 46 in a stored condition (see FIG. 3). Frame 78 is configured to removably support the sets 36 of panels 38 when the windbreak 30 is advanced in the forward direction F by the vehicle.

The sets 36 of panels 38 are each shiftable between the stored condition (see FIG. 3), in which each set 36 is supported at least partly within a respective storage area 74 by the wheeled chassis 34 for transport therewith, and a deployed condition (e.g., see FIGS. 1 and 2). One or more panels 38 of sets 36 may be deployed to extend outside of the respective storage area 74 to form a windbreak structure. Each set 36 may have three (3) panels 38 that may be extended laterally to form a windbreak structure of various sizes and configurations.

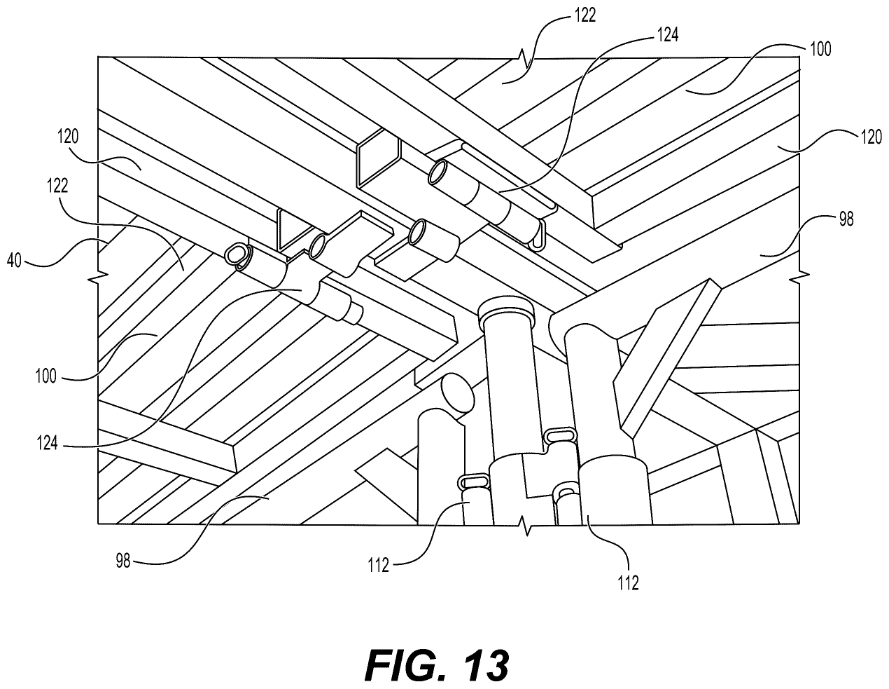

Turning to FIGS. 8-16, collapsible shelters 40 of the windbreak 30 may provide a protective structure for sheltering livestock (such as cattle or horses), people, or other items. Shelters 40 of the portable windbreak 30 may be shifted relative to the wheeled chassis 34 between the deployed condition (see FIGS. 1 and 2) to provide covered areas 94 and the stored condition (see FIGS. 3, 15, and 16) in which the shelters 40 are folded for storage and transport. Each shelter 40 may include upright walls 96 and 98 and a roof 100 (see FIG. 8) supported above the upright walls 96 and 98. As will be described, each roof 100 may be supported by walls 96 and 98 of the respective shelter 40.

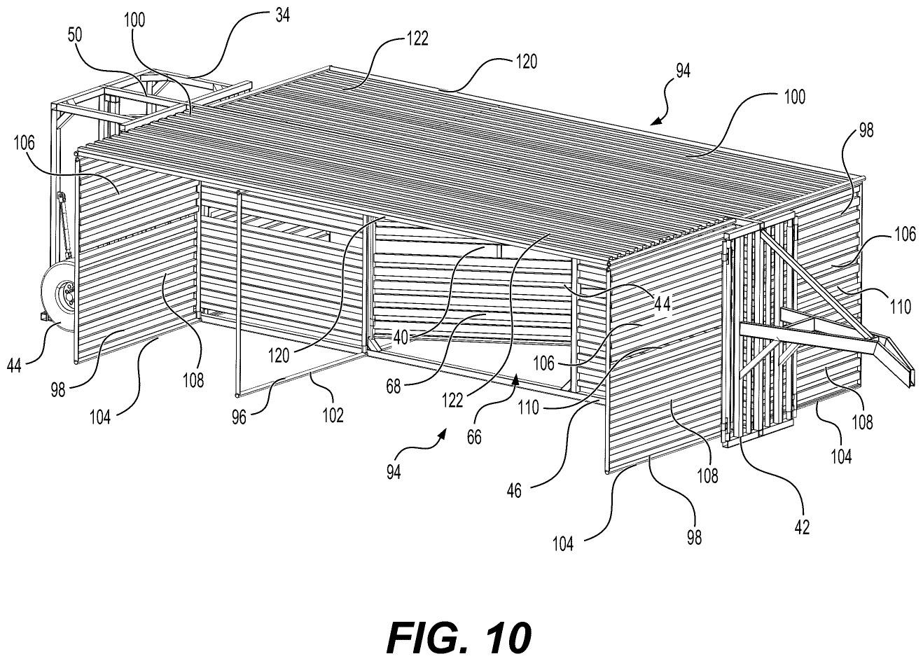

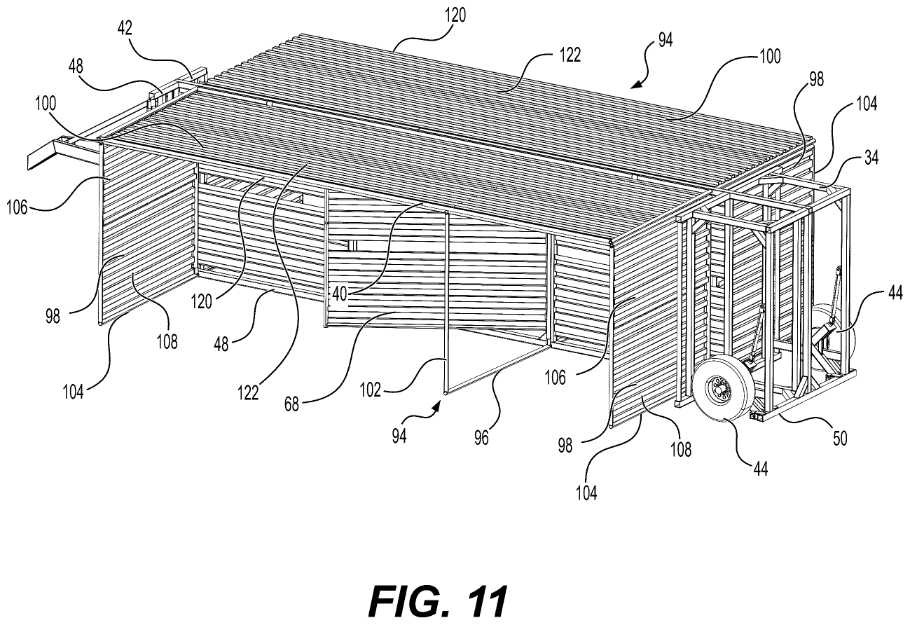

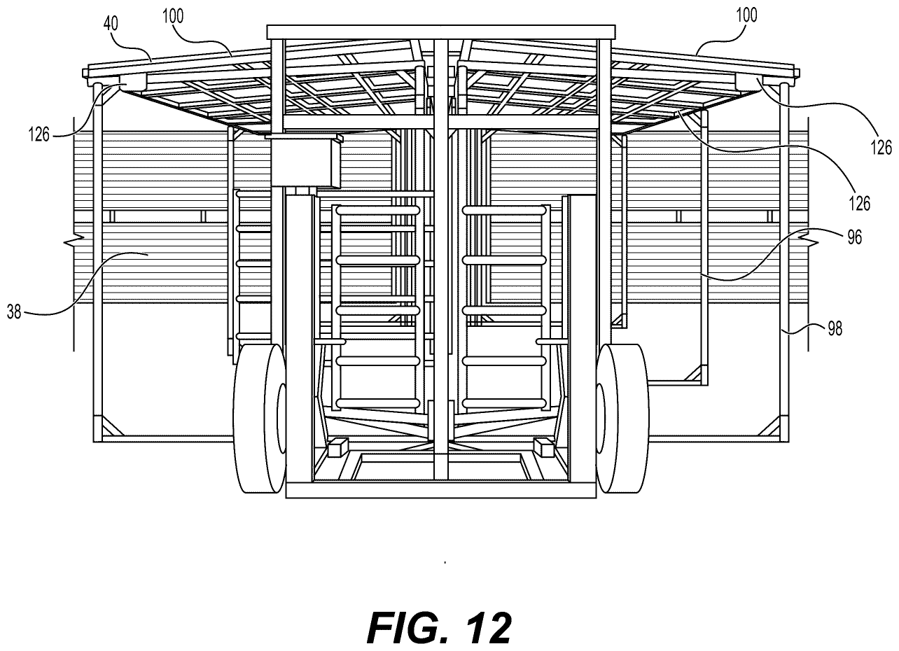

Walls 96 and 98 may be unfolded (e.g., into the deployed condition) relative to the wheeled chassis 34 (see FIG. 8). Walls 96 and 98 may also be folded (e.g., into the stored condition) for storage and transport with the wheeled chassis 34 (see FIG. 3). Each wall 96 may include a tubular frame 102 (see FIG. 9). Each wall 98 may include a tubular frame 104 (FIGS. 8 and 9), an upper sheet section 106 (see FIGS. 10 and 11), and a lower sheet section 108 (see FIGS. 10 and 11). It at least some embodiments of the disclosure, walls 96 and 98 may not include sheet sections (see FIG. 12).

The upper and lower sheet sections 106 and 108 may span the length of the wall 98 (see FIGS. 10 and 11). Sheet sections 106 and 108 may each include a solid material sheet that at least partly covers an opening defined by the tubular frame 104. Each pair of adjacent upper and lower sheet sections 106 and 108 may be spaced apart to define a relief opening 110 (see FIG. 10) that permits limited air flow (such as wind flow) through the wall 98. It will also be understood that upper and lower sheet sections 106 and 108 may restrict other weather (such as rain and show) from passing through the wall 98.

Each wall 96 and 98 may be pivotally attached to the wheeled chassis 34 (see FIGS. 9, 13, and 14). Walls 96 and 98 are preferably configured to be folded (see FIG. 3) into and out of at least partial registration with the spine 46 of wheeled chassis 34. Walls 96 and 98 may also be unfolded (see FIGS. 9-11) to restrict airflow in covered areas 94 extending along opposite sides of the spine 46.

Each wall 96 and 98 may be pivotally attached to the wheeled chassis 34 by upper and lower wall pivot joints 112 (see FIGS. 5, 9, 13, and 14). The wall pivot joints 112 may permit relative swinging movement of the walls 96 and 98 relative to the wheeled chassis 34 about an upright pivot axis. Walls 96 and 98 may be unfolded into the deployed condition so as to extend transversely relative to the spine 46 and support the corresponding roof 100. Walls 96 and 98 may also be folded into the stored condition, in which the walls 96 and 98 extend generally parallel to the spine 46 (see FIG. 5).

Each shelter 40 may include a pair of walls 98 at opposite ends of the spine 46 and a single wall 96 spaced between the walls 98 (see FIGS. 8 and 9). For at least certain aspects of the disclosure, the shelter may have an alternative number of walls 96 and 98. Aspects of the shelter may have one or more walls alternatively positioned along the length of the spine.

Furthermore, one or more walls of the shelter may be alternatively configured. For certain aspects of the disclosure, at least one shelter may be devoid of one or more of the walls.

Each roof 100 may be unfolded (e.g., into the deployed condition) relative to the wheeled chassis 34 (see FIGS. 8 and 12-14). Roof 100 may also be folded (e.g., into the stored condition) for storage and transport with the wheeled chassis 34 (see FIGS. 3, 15, and 16). Each roof 100 may include a tubular frame 120 and a sheet section 122 (see FIGS. 8, 9, and 12-14).

Sheet section 122 may span the length of the roof 100 (see FIG. 8). Sheet section 122 may include a solid material sheet that at least partly covers an opening defined by the tubular frame 120.

Each roof 100 may be pivotally attached to the wheeled chassis 34 (see FIGS. 1 and 2). Roof 100 may be folded (see FIG. 3) into and out of at least partial registration with the spine 46 of wheeled chassis 34. Roof 100 may also be unfolded (see FIGS. 1 and 2) to cover and restrict airflow in covered areas 94 extending along opposite sides of the spine 46.

Roof 100 may be pivotally attached to the wheeled chassis 34 by roof pivot joints 124 (see FIGS. 9, 13, and 14). Roof pivot joint 124 may comprise a hinge mechanism with a removable pin. The roof pivot joints 124 may permit relative swinging movement of the roof 100 relative to the wheeled chassis 34 about a lateral axis. Roof 100 may be unfolded and raised into the deployed condition so as to extend transversely relative to the spine 46 (see FIGS. 10-14). As noted, roof 100 may be supported in the deployed condition by walls 96 and 98 of the corresponding shelter 40 (see FIG. 12). Roof 100 may also be folded into the stored condition (see FIGS. 3, 15, and 16), in which the roof 100 extends generally parallel to the spine 46.

When deployed, the roof 100 may extend perpendicularly relative to the spine 46 (see FIGS. 10 and 11). It is also within the scope of the disclosure for at least one roof to extend at an oblique angle relative to the spine when supported in the deployed condition (see FIGS. 12-14). For example, the roof may slope downwardly in an outboard direction relative to the roof pivot joints (see FIGS. 12-14). The roof may also slope upwardly in the outboard direction relative to the roof pivot joints. Sloping of the roof may permit the roof to shed water, snow, dirt, and/or foreign objects. The sloped roof may also be positioned to provide enhanced protection of livestock (such as cattle or horses), people, or other items within and/or adjacent the covered area 94.

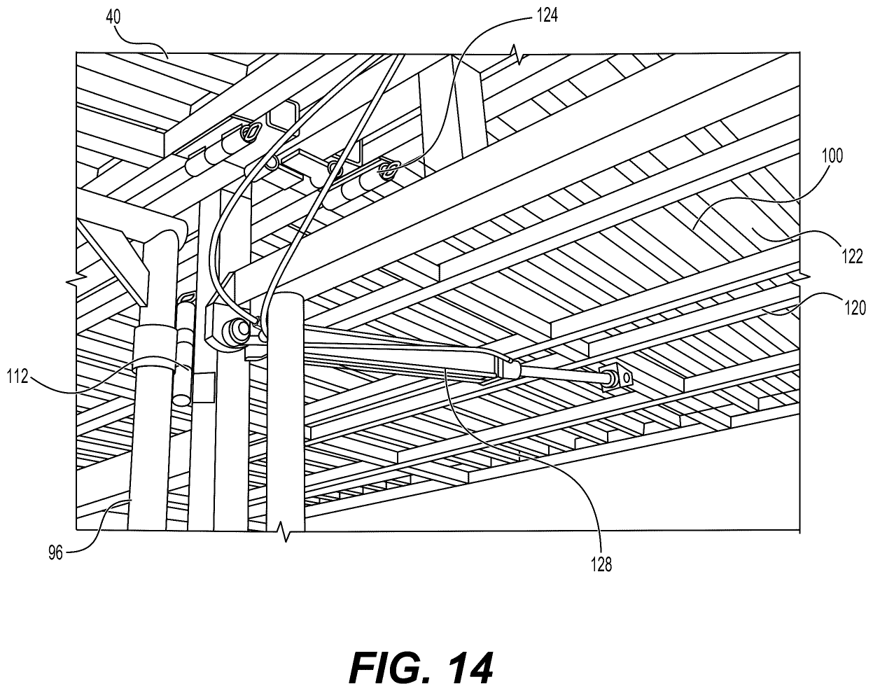

Roof 100 may be held in an extended position above the walls 96 and 98 by a structural support, such as the walls 96 and 98, another support element, or combinations thereof. For example, the depicted roof 100 may include brackets 126 that are removably engaged with and attached to respective walls 96 and 98 (see FIG. 12). Each bracket 126 may comprise a pair of plates configured to be located on opposite sides of a respective wall 96,98, and a pin for removably securing the wall 96,98 to the bracket 126. In other aspects of the disclosure, the shelter 40 may include a brace operable to hold the roof 100 extended. Such a brace may be used additionally or alternatively to walls 96 and 98 to support the roof 100. Other aspects of the disclosure may include a motor, such as a hydraulic cylinder 128 (see FIG. 14), that drivingly engages the roof 100 to swing the roof 100 between folded and unfolded positions. Aspects of a structural support may be used when the roof 100 and walls 96 and 98 are deployed. The structural support may also be utilized during folding and unfolding of roof 100 (e.g., to support the roof without the roof being supported by walls 96 and 98). For instance, a piston of the hydraulic cylinder 128 may be selectively retracted to fold the roof 100 and extended to unfold the roof 100.

Each shelter 40 may include a single roof 100 that extends continuously between opposite ends of the spine 46. For at least certain aspects of the disclosure, the shelter may have more than one roof. Aspects of the shelter may have a roof alternatively positioned along the length of the spine. Furthermore, at least one roof may be alternatively configured. For certain aspects of the disclosure, at least one shelter may be devoid of a roof. Within the scope of certain aspects of the disclosure, windbreak may be devoid of any shelter 40 (e.g., where the windbreak includes the wheeled chassis and sets of panels without any shelters).

As noted above, the sets 36 of panels 38 may be selectively unfolded into the deployed condition. With each set 36 of panels 38 unfolded from being located alongside the folded shelters 40, each shelter 40 may be accessed by the user. Shelters 40 may then be unfolded and erected into the deployed condition.

Each shelter 40 may be erected by unfolding the roof 100 away from the folded location alongside the folded walls 96 and 98. Roof 100 may be raised relative to the wheeled chassis 34 so that the roof 100 extends outboard relative to the spine 46. With the roof 100 extended, walls 96 and 98 may be unfolded relative to the wheeled chassis 34 into the deployed condition so as to extend transversely relative to the spine 46 and support the corresponding roof 100. At least one of walls 96 and 98 may be unfolded while the associated roof 100 is being held in a position above the walls 96 and 98 by a person or by a structural support.

To return the shelter 40 from the deployed condition to the stored condition, walls 96 and 98 may be folded to extend generally parallel to the spine 46. Folding of walls 96 and 98 may be done while the associated roof 100 is being held in a position above the walls 96 and 98 by a person or by a structural support. With the walls 96 and 98 folded, roof 100 may be returned to the folded position so that the shelter 40 is stored. Sets 36 of panels 38 may then be selectively folded into the stored condition, in which each set 36 of panels 38 may be located alongside the folded shelters 40.

In one or more embodiments, the frame, panels, shelters, and/or other rigid components of the portable windbreak may be formed of a metal material, such as steel or carbon steel. However, it is within the scope of the present invention for one or more components to include an alternative metal (such as stainless steel, aluminum, etc.), alloys thereof, or a non-metal material (such as a synthetic resin).

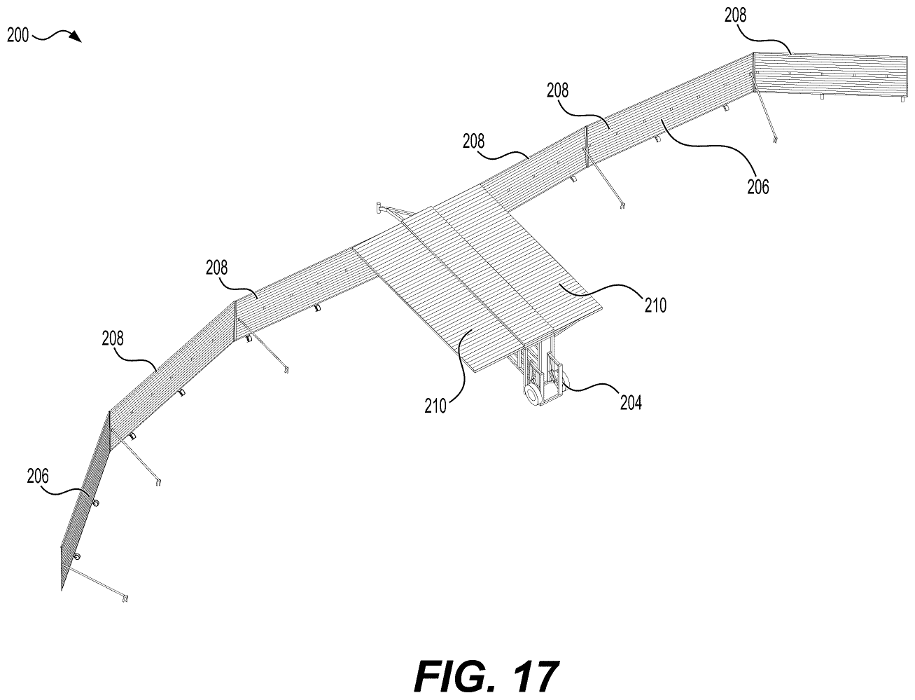

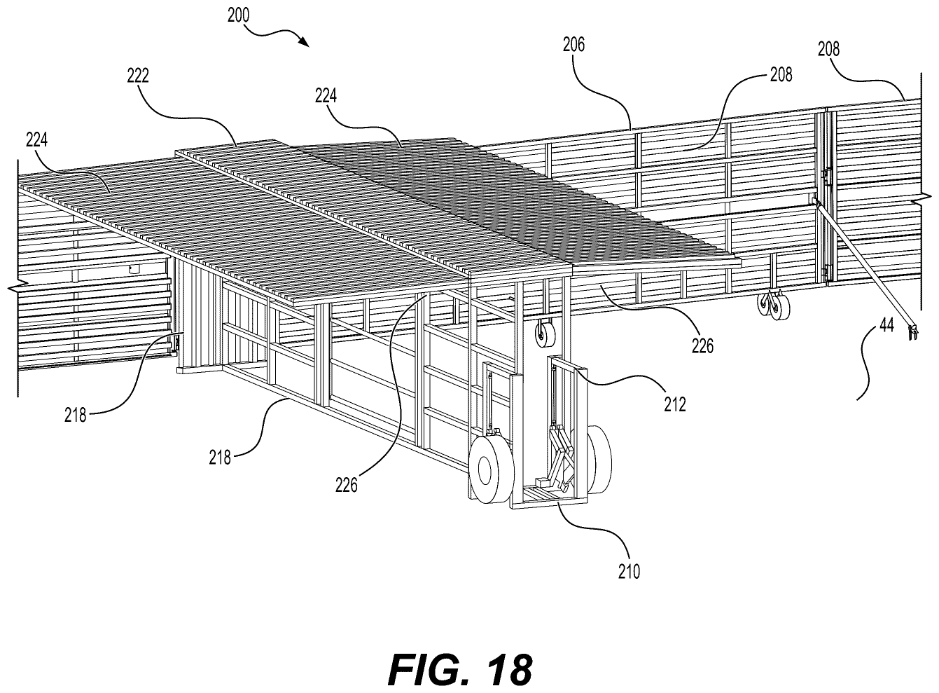

Turning to FIGS. 17-36B, alternative preferred embodiments of the present invention are depicted. For the sake of brevity, the remaining description will focus primarily on the differences of these alternative embodiments from the embodiment described above.

Initially turning to FIGS. 17-23, another embodiment of a portable windbreak 200 is depicted. The portable windbreak 200 may include a wheeled chassis 204, opposed sets 206 of panels 208, and alternative collapsible shelters 210. Wheeled chassis 204 may include an elongated frame 212 and ground-engaging transport wheels 214.

The depicted frame 212 preferably includes a spine 216 and spaced apart forward and aft sections 218 and 220 connected by the spine 216. The wheeled chassis 204 may also include a fixed roof 222 secured to an upper portion of the frame 212.

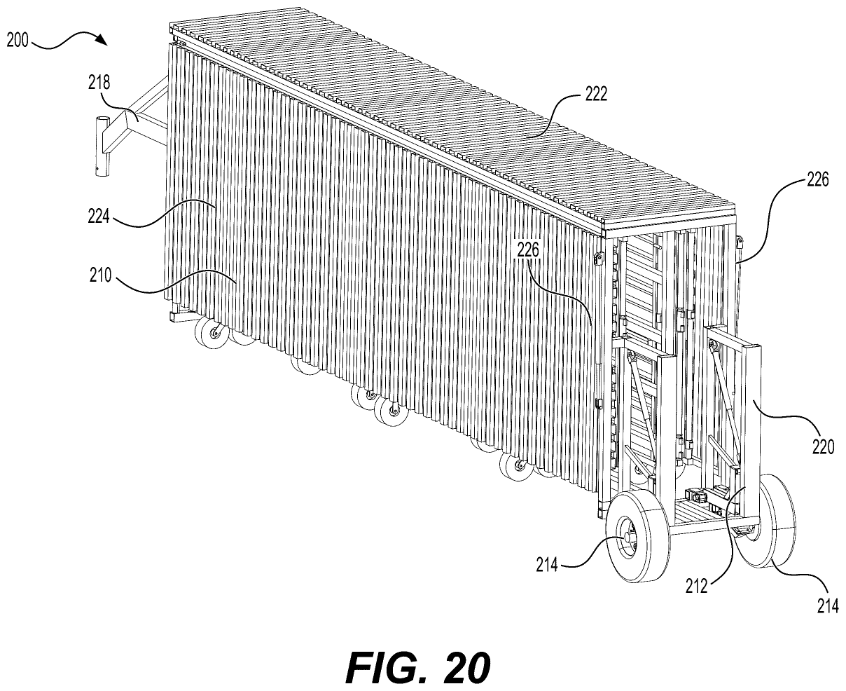

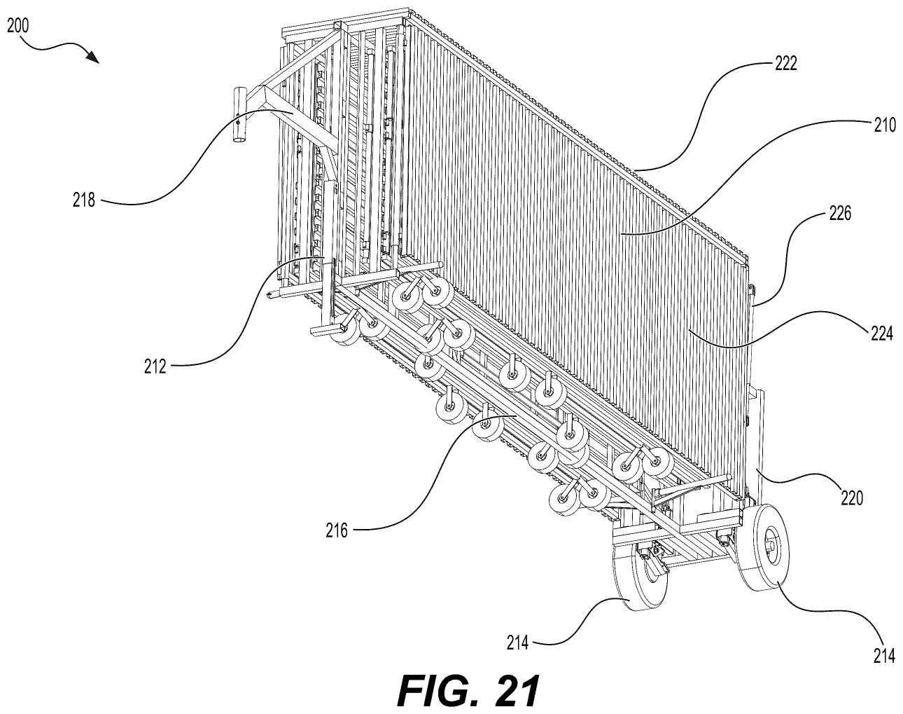

Collapsible shelters 210 of the windbreak 200 may be shifted relative to the wheeled chassis 204 between the deployed condition (see FIGS. 17-19) to provide covered areas and the stored condition (see FIGS. 20 and 21) in which the shelters 40 are folded for storage and transport. Each shelter 210 may include a shiftable roof 224 and a hydraulic cylinder 226 configured to support and swing the shiftable roof 224. As will be described, each roof 224 is configured to be positioned outboard of the adjacent set 206 of panels 208 in the stored condition.

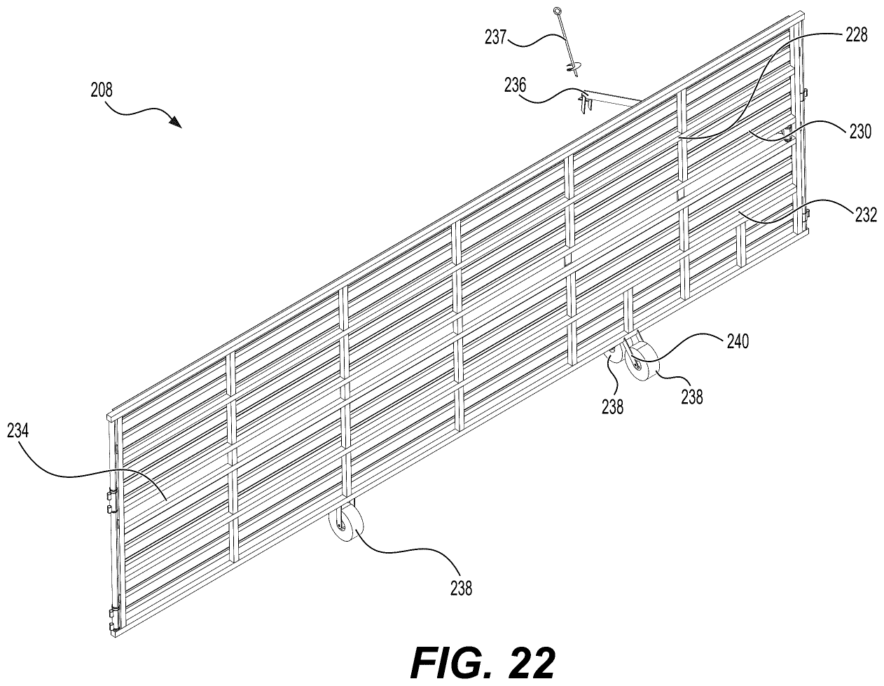

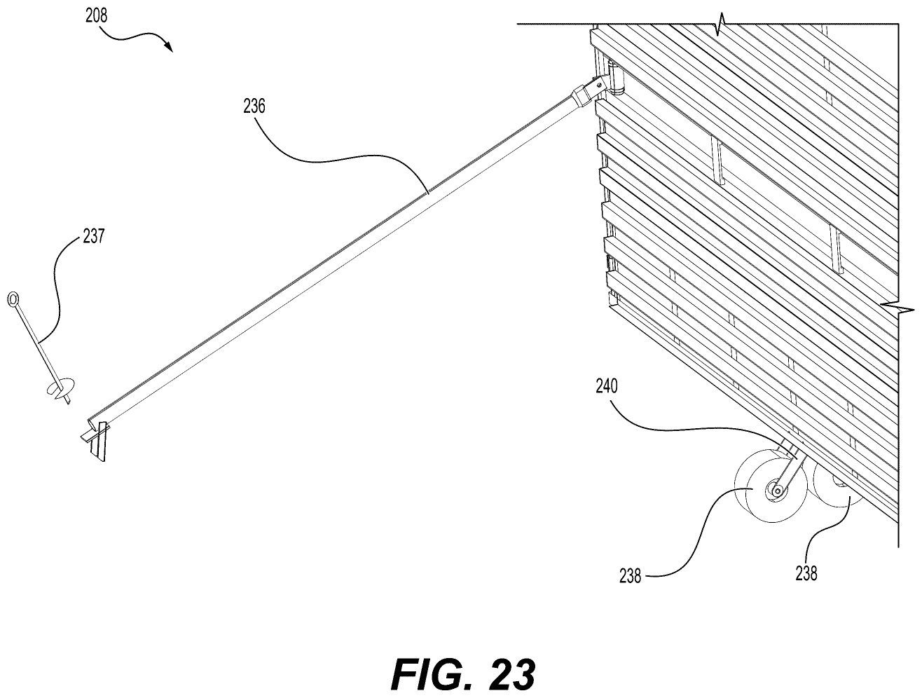

Similar to panels 38, panels 208 may be unfolded (e.g., into the deployed condition) relative to the wheeled chassis 204 (see FIGS. 17-19). Panels 208 may be folded (e.g., into the stored condition) for storage and transport with the wheeled chassis 204 (see FIGS. 20 and 21). Each panel 208 may include a frame 228, an upper sheet section 230, and a lower sheet section 232 (see FIGS. 22 and 23).

The upper and lower sheet sections 230 and 232 may span the length of the panel 208 (see FIG. 22). Each pair of adjacent upper and lower sheet sections 230 and 232 may be spaced apart to define a relief opening 234 that permits limited air flow (such as wind flow) through the panel 208. The upper and lower sheet sections 63 and 64 may restrict other weather (such as rain and show) from passing through the panel 208.

Each panel 208 may also include a shiftable brace 236. The brace 236 may be shiftable into and out of a deployed position (see FIGS. 22 and 23) in which the brace 236 extends downwardly from the frame 228 to engage the ground. Brace 236 may also be shiftable into and out of a stored position (not shown) in which the brace 236 is supported by the frame 228 in a location spaced above the ground. A ground-engaging end of the brace 236 may be removably secured to the ground via an anchor 237 (see FIG. 23).

Each panel 208 may further include panel wheels 238 and wheel brackets 240 that depend from the frame 228 to rotatably support the panel wheels 238. The pair of panel wheels 238 are configured to support the frame 228 above the ground and roll across the ground to permit swinging movement of the wheeled panel.

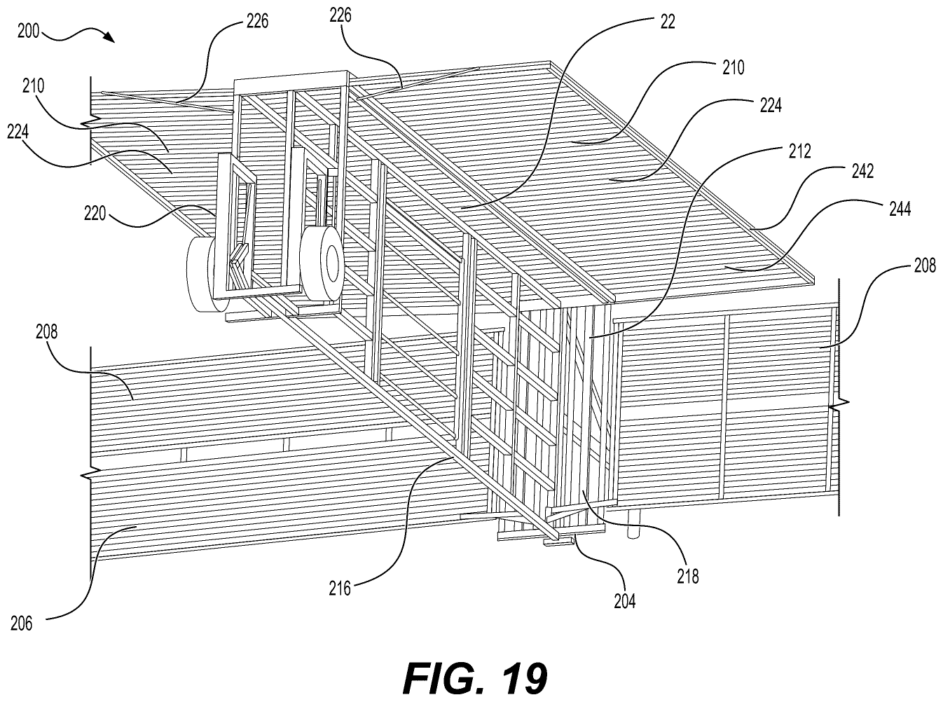

Again, each roof 224 is configured to be positioned outboard of the adjacent set 206 of panels 208 in the stored condition. The roof 224 may be unfolded (e.g., into the deployed condition) relative to the wheeled chassis 204 (see FIGS. 17-19). Roof 224 may also be folded (e.g., into the stored condition) for storage and transport with the wheeled chassis 204 (see FIGS. 20 and 21). Each roof 224 may include a tubular frame 242 and a sheet section 244 (see FIG. 19).

Each roof 224 may be pivotally attached to the wheeled chassis 204 via pivot joints (not shown). Roof 224 may be folded (see FIG. 21) into and out of at least partial registration with the spine 216 of wheeled chassis 204. Roof 224 may also be unfolded (see FIGS. 17-19) to cover and restrict airflow in covered areas extending along opposite sides of the spine 216.

The hydraulic cylinder 226 may drivingly engage the roof 224 to swing the roof 224 between the folded and unfolded positions. For instance, a piston of the hydraulic cylinder 226 may be selectively retracted to fold the roof 224 and extended to unfold the roof 224.

Each shelter 210 may be erected by unfolding the roof 224 away from the folded location alongside the respective panels 208. Roof 224 may be raised relative to the wheeled chassis 204 so that the roof 224 extends outboard relative to the spine 216. With the roof 224 extended, respective panels 208 may be unfolded relative to the wheeled chassis 204 into the deployed condition so as to extend transversely relative to the spine 216.

To return the shelter 210 from the deployed condition to the stored condition, roof 224 may be lowered to the folded position so that the shelter 210 is stored. In the depicted embodiment, respective panels 208 may first be folded into the stored condition. With the panels 208 stored, the roof 224 may be lowered so that the roof 224 is outboard of the respective panels 208 in the stored condition.

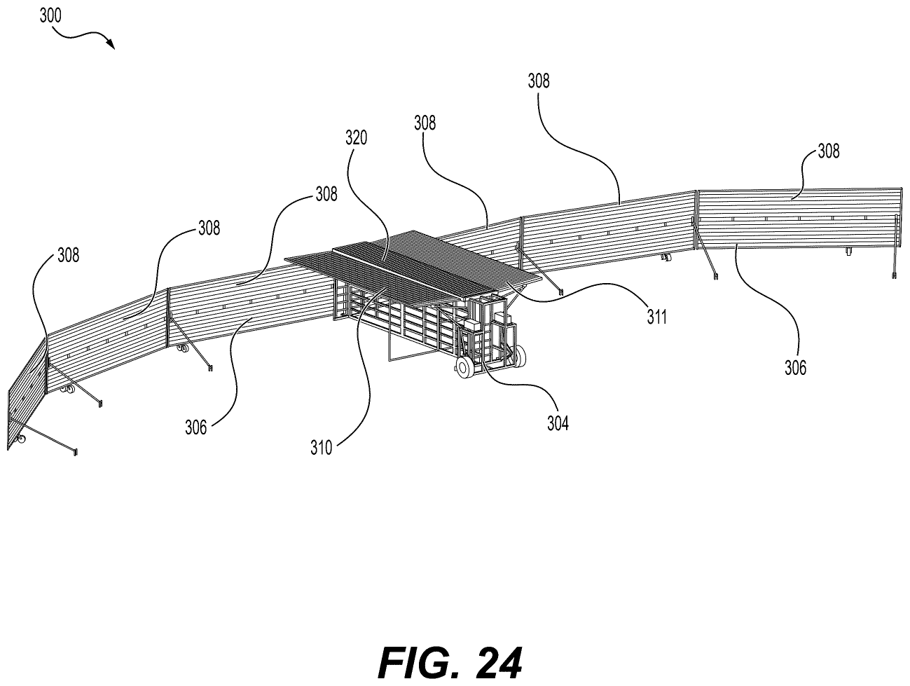

Turning to FIGS. 24-36B, another embodiment of a portable windbreak 300 is depicted. The portable windbreak 300 may include a wheeled chassis 304, opposed sets 306 of panels 308, and collapsible shelters 310 and 311.

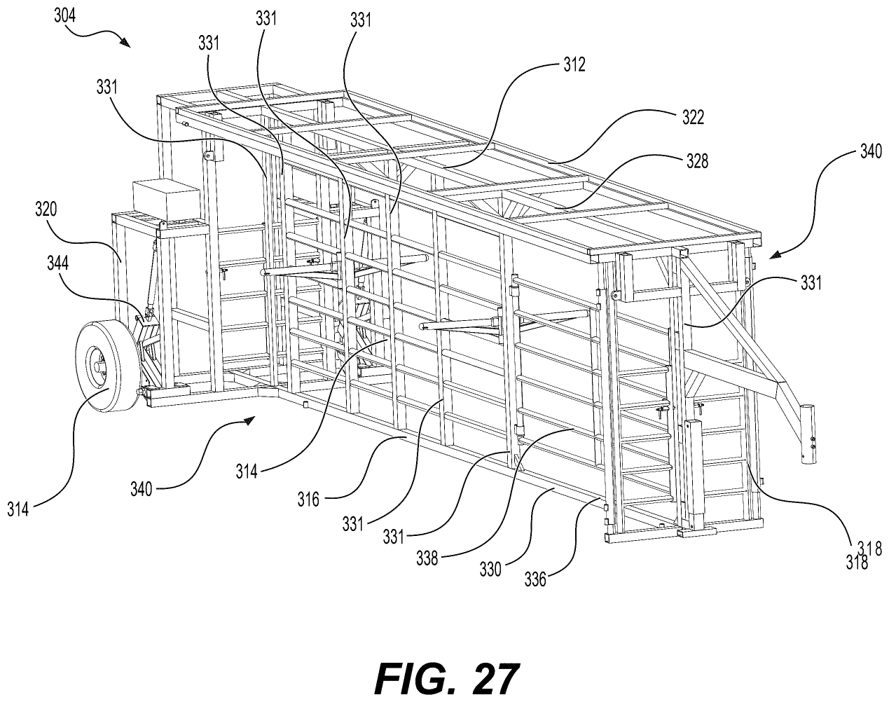

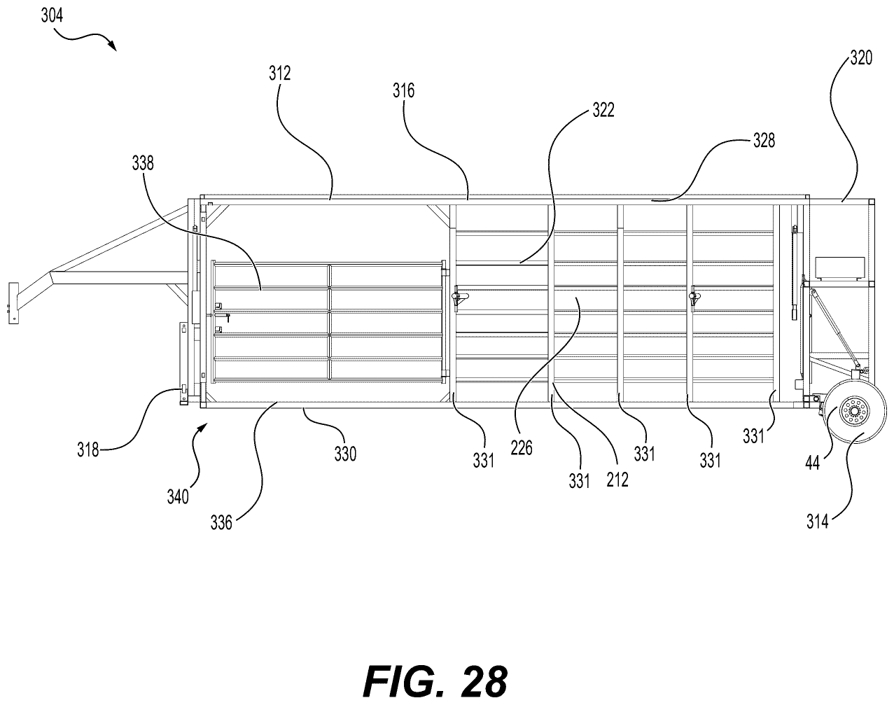

In the illustrated embodiment, wheeled chassis 304 may include an elongated frame 312 and ground-engaging transport wheels 314 (see FIGS. 27 and 28). Transport wheels 314 may be independently shiftable relative to the frame 312 and operable to support the frame 312 above ground.

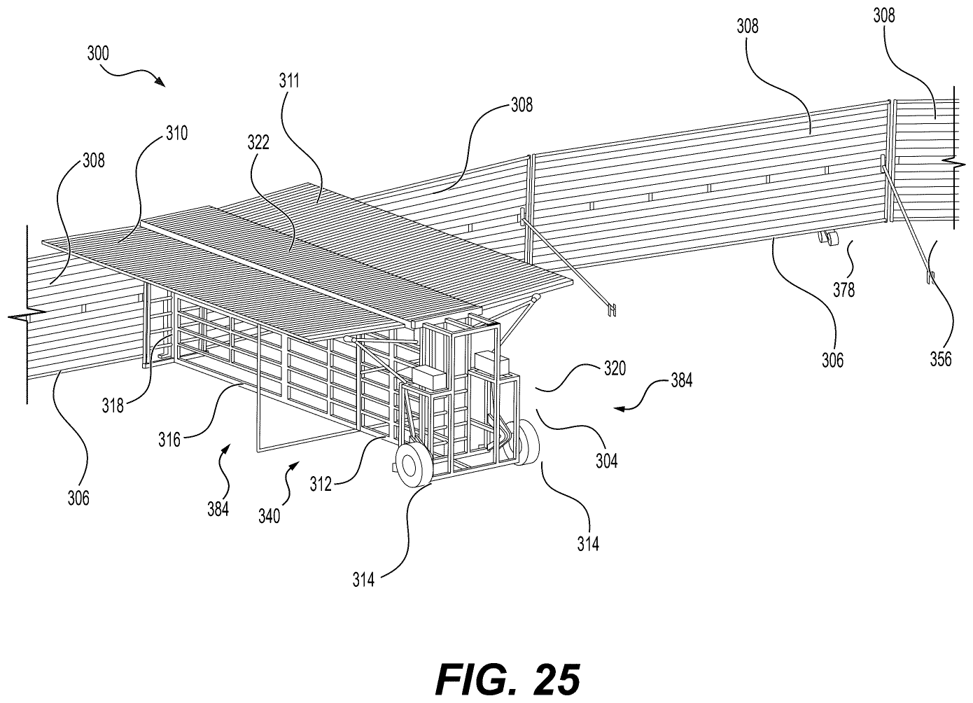

The depicted frame 312 preferably includes a spine 316 and spaced apart forward and aft sections 318 and 320 connected by the spine 316 (see FIGS. 27 and 28). The wheeled chassis 304 may also include a fixed roof 322 (see FIG. 25) secured to an upper portion of the frame 312.

Spine 316 extends longitudinally along the forward direction. The spine 316 preferably comprises a wall with upper and lower tubular beams 328 and 330 and tubular uprights 331 welded to form a monolithic and rigid weldment (see FIGS. 27 and 28). Tubular beams 328 and 330 and tubular uprights 331 preferably comprise tubular members. The spine 316 may also include a swingable gate, as will be described. The depicted spine 316 may be devoid of sheet sections (similar to sheet sections 63 and 64 described above), although spine embodiments may include one or more sheet sections (e.g., to restrict air flow from passing from one side of the spine 316 to the other side of the spine 316).

Spine 316 may also present an opening 336 (see FIGS. 27 and 28) that permits users and livestock to move from one side of the spine 316 to the other side of the spine 316. Opening 336 may be selectively opened and closed by swingable gate 338, which is configured to be swung between an open position (not shown) and a closed position (see FIGS. 27 and 28). Gate 338 as depicted may also be devoid of sheet sections, although other gate embodiments may include upper and lower sheet sections that are spaced apart to define a relief opening.

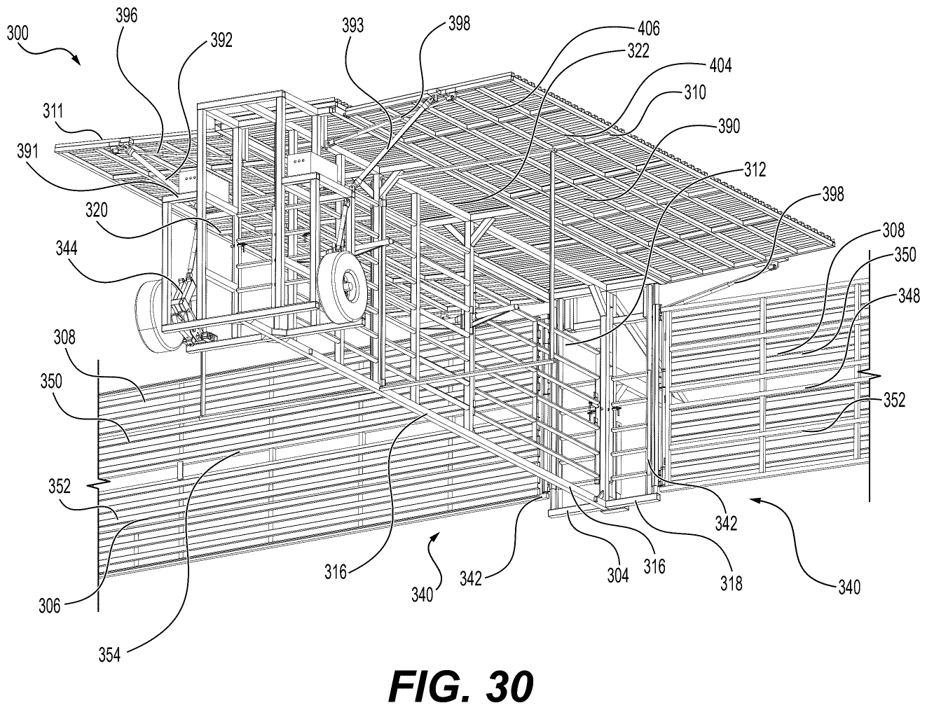

Forward and aft sections 318 and 320 also preferably comprise tubular members fixed relative to one another to form a rigid weldment. The forward and aft sections 318 and 320 cooperate with the spine 316 to define opposed storage areas 340 (see FIG. 30) configured to receive corresponding panels 308. The illustrated transport wheels 314 are associated with the aft section 320 and spaced rearwardly of the storage areas 340.

The forward and aft sections 318 and 320 each extend outboard of the spine 316 in opposite lateral directions so that the spine 316 and the forward and aft sections 318 and 320 cooperatively define the opposed storage areas 340. Furthermore, the forward section 318 includes opposite outboard margins 342 (see FIG. 30) to which the sets 306 of panels 308 are pivotally attached. It is also within the scope of certain aspects of the present invention for one or both of the forward and aft sections to be alternatively configured. For at least some aspects of the present invention, the frame may include one or more alternative storage areas to receive panels. For instance, a storage area may be alternatively defined by one or more components of the frame.

The wheeled chassis 304 may further include two suspensions 344 (see FIGS. 27, 29, 30 and 33) and spindles (not shown) supported by the suspensions 344. In the usual manner, spindles rotatably receive the transport wheels 314. The suspension 344 is configured to shiftably support the spindles and transport wheels 314 relative to the frame 312. Additional preferred details of the suspension 344, as well as other suspension embodiments, are disclosed by the above-incorporated '158 patent.

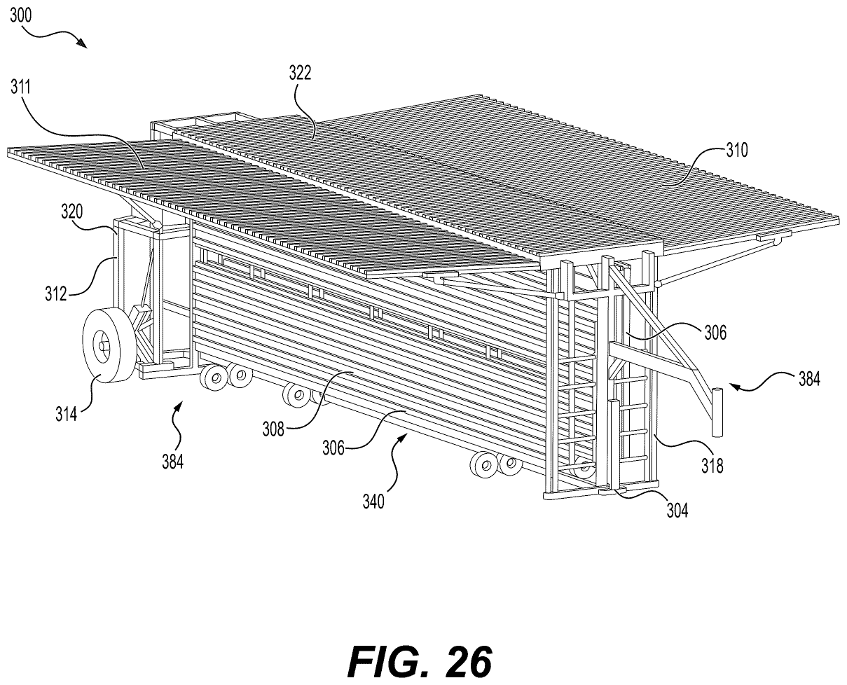

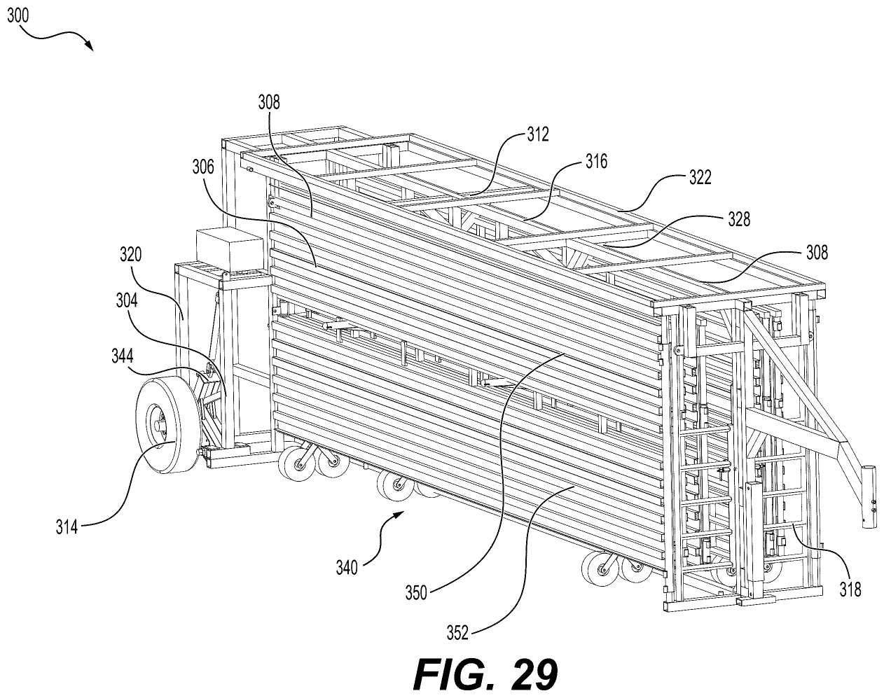

Panels 308 may be unfolded (e.g., into the deployed condition) relative to the wheeled chassis 304 (see FIGS. 24 and 25). Panels 308 may be folded (e.g., into the stored condition) for storage and transport with the wheeled chassis 304 (see FIGS. 26, 29, and 33). Each panel 308 may include a panel frame 348, an upper sheet section 350, and a lower sheet section 352 (see FIGS. 29-32, 36A and 36B).

The upper and lower sheet sections 350 and 352 may span the length of the panel 308 (see FIG. 29). Sheet sections 350 and 352 may each include a solid material sheet that at least partly covers an opening defined by frame 348. Each pair of adjacent upper and lower sheet sections 350 and 352 may be fixed relative to frame 348 to restrict wind flow through the panel 308. Each pair of adjacent upper and lower sheet sections 350 and 352 may be spaced apart to define a relief opening 354 (see FIG. 30) that permits limited air flow (such as wind flow) through the panel 308. It will be understood that upper and lower sheet sections 350 and 352 may restrict other weather (such as rain and show) from passing through the panel 308.

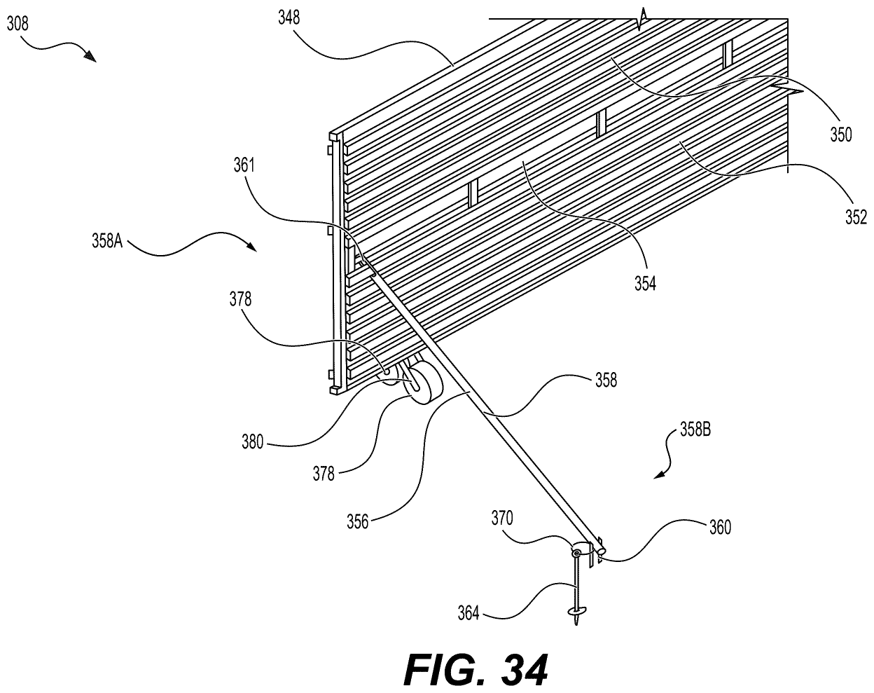

Turning to FIGS. 34-36B, each panel 308 may also include a shiftable brace 356 shiftably attached relative to the panel frame 348. The brace 356 may be shiftable into and out of a deployed position (see FIG. 34) in which the brace 356 extends downwardly from the frame 348 to engage the ground. Brace 356 may also be shiftable into and out of a stored position (not shown) in which the brace 356 is supported by the frame 348 in a location spaced above the ground.

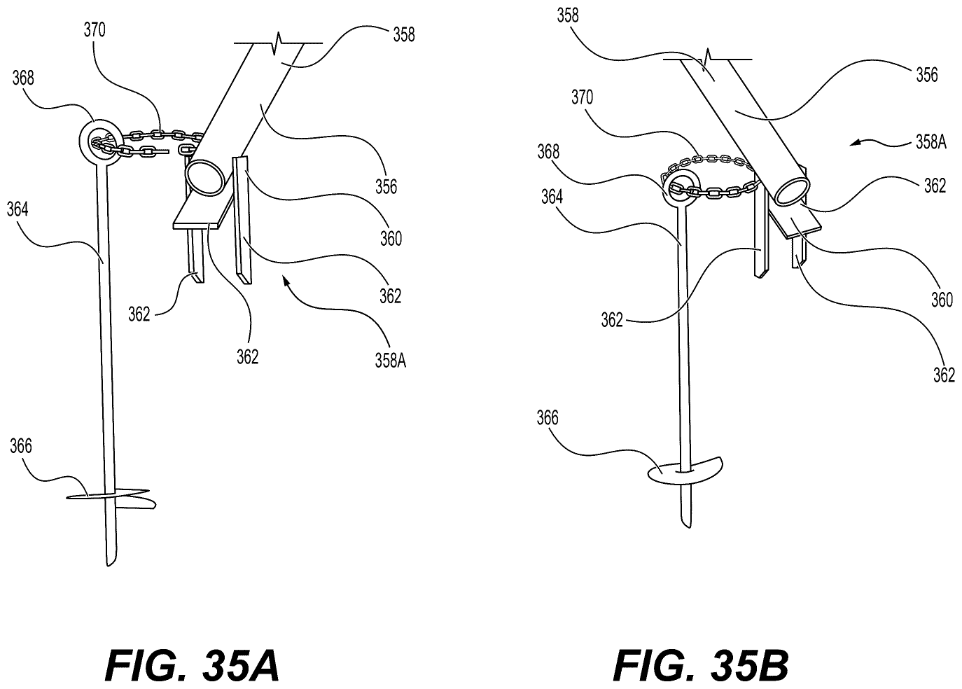

Brace 356 may include a tubular arm 358, a ground-engaging portion 360 fixed to a distal end 358A of the arm 358, and a pivot assembly 361 attached relative to the panel frame 348 (see FIG. 34). The ground-engaging portion 360 may include elongated stake elements 362 fixed to the arm 358 (see FIGS. 35A and 35B) and configured to be driven into the ground.

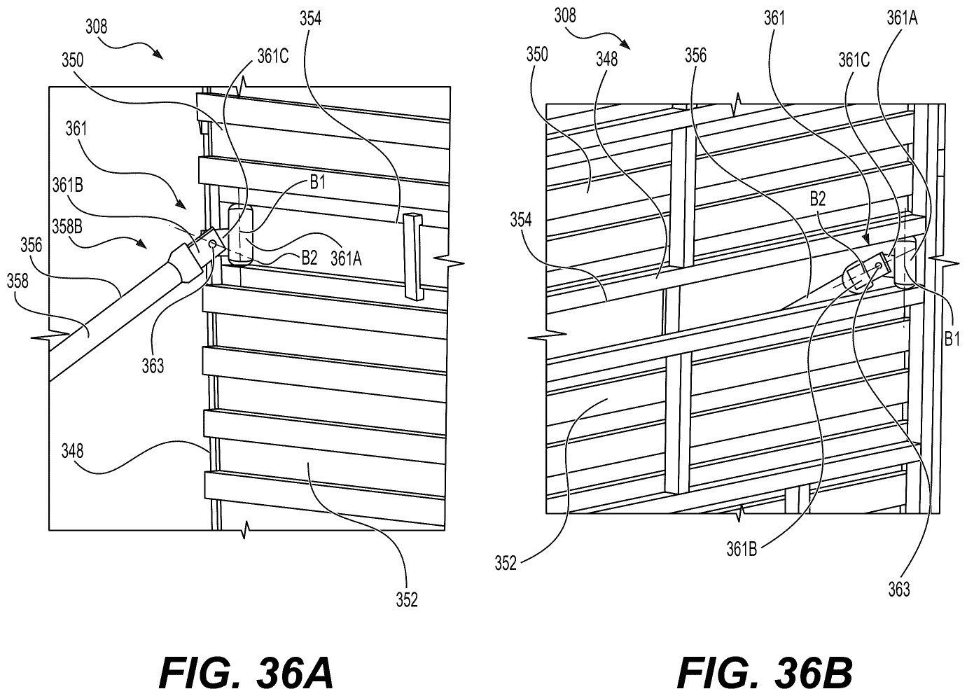

The pivot assembly 361 may include a sleeve 361A and a flange 361B (see FIGS. 36A and 36B). The sleeve 361A may be rotatably mounted relative to the panel frame 348 for rotation about an upright brace pivot axis B1 (see FIGS. 36A and 36B). The sleeve 361A may include a tab 361C pivotally attached to the flange 361B at an arm pivot joint 363 (see FIGS. 36A and 36B). The flange 361B may be fixed adjacent a proximal end 358B of the arm 358 (see FIG. 36A). The arm pivot joint 363 may permit the arm 358 to swing relative to the panel frame 348 about a lateral brace pivot axis B2.

The ground-engaging portion 360 may be removably secured to the ground via an anchor 364 (see FIG. 6). Anchor 364 may comprise a spiral ground anchor including a spiral flute 366 and an eye 368. The anchor 364 may be secured in the ground by spinning the eye 368 so that the spiral flute 366 augers the anchor 364 downwardly into the ground. With the anchor 364 secured in the ground, the brace 356 may be secured to the anchor 364 by attaching a chain 370 to the eye 368 and attaching the chain 370 relative to the ground-engaging portion 360 of the brace 356.

The chain 370 may be preferred for interconnecting the anchor 364 and brace 356. In other embodiments, the anchor and brace may be removably attached relative to one another with other fastening elements, such as a rope, wire, threaded fasteners, etc.

Each panel 308 may further include a pair of panel wheels 378 and wheel brackets 380 that depend from the frame 78 to rotatably support the panel wheels 378 (see FIG. 34). The pair of panel wheels 378 are configured to support the frame 348 above the ground and roll across the ground to permit swinging movement of the wheeled panel.

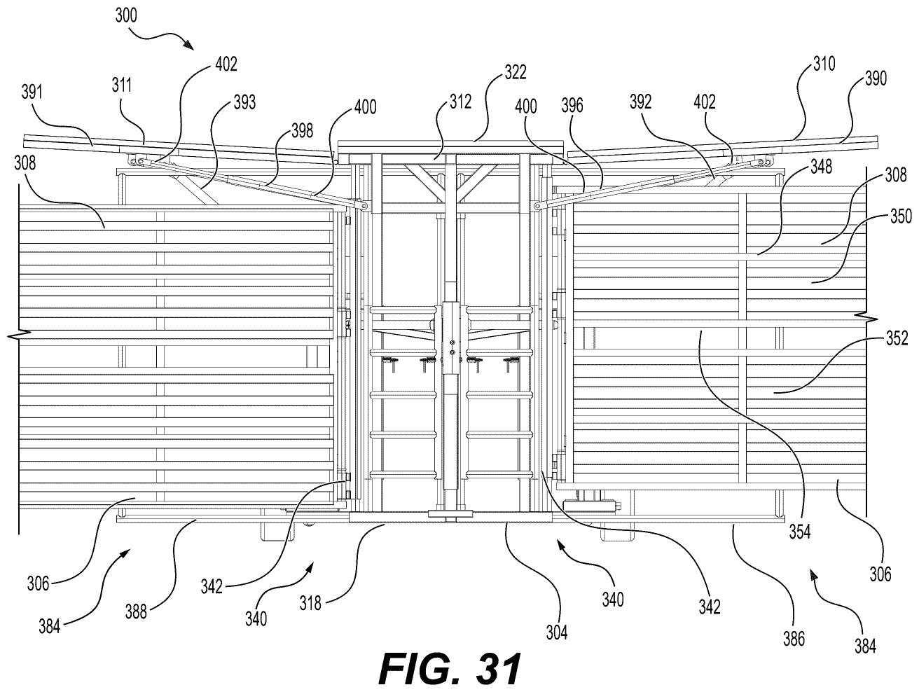

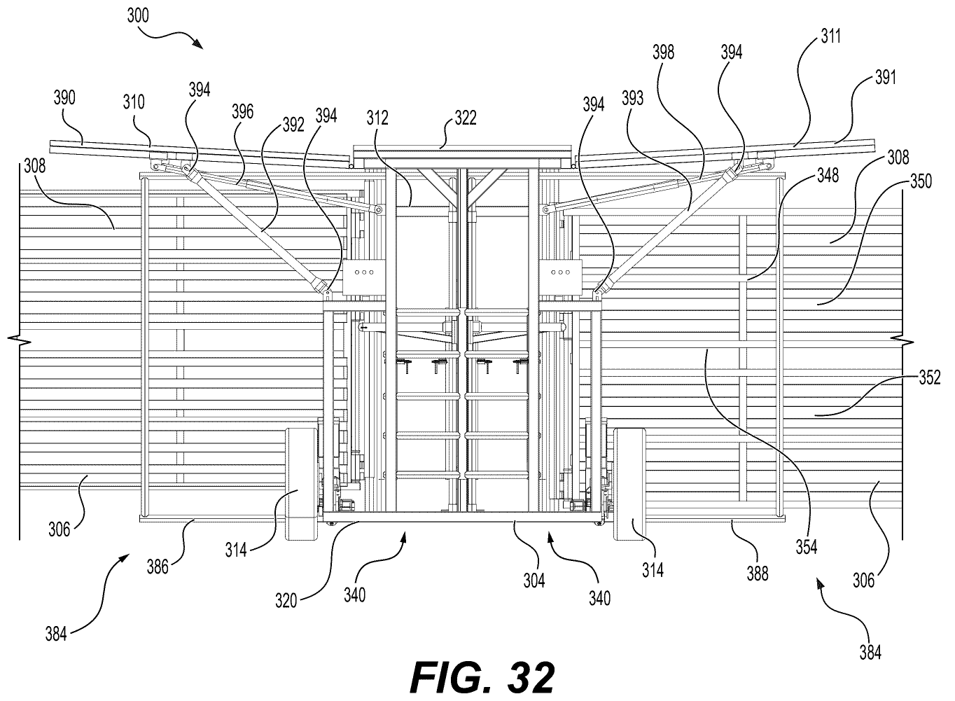

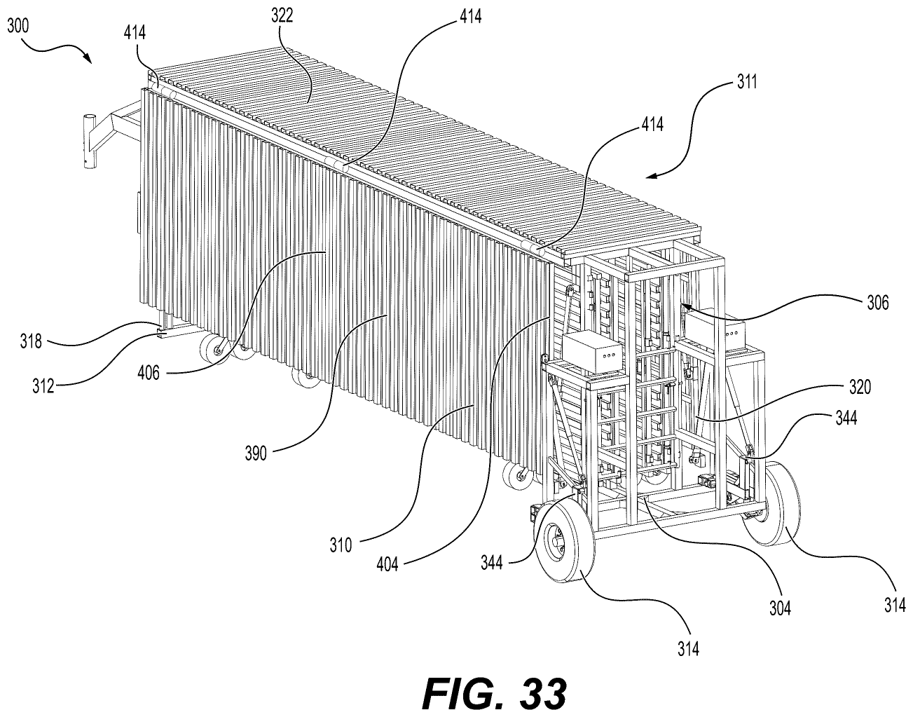

Turning to FIGS. 24-26 and 30-33, collapsible shelters 310 and 311 of the windbreak 300 may provide a protective structure for sheltering livestock (such as cattle or horses), people, or other items. Shelters 310 and 311 of the portable windbreak 300 may be shifted relative to the wheeled chassis 304 between the deployed condition (see FIGS. 24-26 and 30-32) to provide covered areas 384 (see FIGS. 31 and 32) and the stored condition (see FIG. 33) in which the shelters 310 and 311 are folded for storage and transport.

Shelter 310 may include an upright bracket 386, a roof 390, and a removable gusset 392 (see FIG. 8). Shelter 311 may include an upright bracket 388, a roof 391, and a removable gusset 393 (see FIG. 8). Each roof 390 and 391 may be attached to and supported by the wheeled chassis 304.

Brackets 386 and 388 may be unfolded (e.g., into the deployed condition) relative to the wheeled chassis 304 (see FIGS. 30-32). Brackets 386 and 388 may also be folded (e.g., into the stored condition) for storage and transport with the wheeled chassis 304. Brackets 386 and 388 are preferably configured to be folded into and out of at least partial registration with the spine 316 of wheeled chassis 304. Each bracket 386 and 388 may comprise a tubular frame (see FIGS. 30-32). Each bracket 386 and 388 may be pivotally attached to the wheeled chassis 304 for shifting between the deployed and stored conditions.

Each gusset 392 and 393 may be removably attached to the wheeled chassis 304 and corresponding roof 390 and 391 by gusset joints 394 (see FIG. 32). Gussets 392 and 393 may be secured to the wheeled chassis 304 and roof 390 and 391 in the deployed condition to support the corresponding roof 390. When secured, gussets 392 and 393 may extend transversely relative to the wheeled chassis 304. The gusset joints 394 may be detachable to permit positioning of the gussets 392 and 393 relative to the wheeled chassis 304. By detaching each gusset 392 and 393 from the respective roof 390 and 391, the roof 390 and 391 may freely swing from the deployed condition toward the stored condition. Gussets 392 and 393 may also be folded into the stored condition.

Shelters 310 and 311 may also include respective pairs of hydraulic cylinders 396 and 398 (see FIGS. 31 and 32). In the usual manner, the hydraulic cylinders 396 and 398 may each include a cylinder body 400 and a piston 402 (see FIG. 31) slidable into and out of the cylinder body 400. As will be described, hydraulic cylinders 396 and 398 may be operated to shift the corresponding roof 390 and 391 between deployed and stored conditions.

Each roof 390 and 391 may be shiftably attached relative to the wheeled chassis 304. The roof 390 and 391 may include a tubular frame 404 and a sheet section 406 (see FIGS. 30 and 33). Sheet section 406 may span the length of the roof 390 and 391. Sheet section 406 may include a solid material sheet that at least partly covers an opening defined by the tubular frame 404.

Preferably, each roof 390 and 391 may be pivotally attached to the wheeled chassis 304 for swinging between the deployed condition (see FIG. 30) and the stored condition (see FIG. 33). The depicted construction permits each roof 390 and 391 to be individually and selectively unfolded (e.g., into the deployed condition) relative to the wheeled chassis 304 (see FIG. 30). For instance, roof 390 and roof 391 may be unfolded (see FIGS. 1 and 2) to cover and restrict airflow in covered areas 384 extending along opposite sides of the spine 316. Roof 390 and roof 391 may also be selectively folded (e.g., into the stored condition) for storage and transport with the wheeled chassis 304 (see FIG. 33). For example, each roof 390 and 391 may be folded (see FIG. 33) into and out of at least partial registration with the spine 316 of wheeled chassis 304.

Roof 390 and 391 may be pivotally attached to the wheeled chassis 304 by roof pivot joints 414 (see FIG. 33). Roof pivot joint 414 may comprise a hinge mechanism with a pin. The roof pivot joints 414 may permit relative swinging movement of the roof 390 and 391 relative to the wheeled chassis 304 about a lateral axis. Each roof 390 and 391 may be unfolded and raised into the deployed condition so as to extend transversely relative to the spine 316 (see FIG. 30). Each roof 390 and 391 may also be folded into the stored condition (see FIG. 33), in which the roof 390 and 391 extends generally parallel to the spine 316.

When deployed, each roof 390 and 391 may extend at an oblique angle relative to the spine 316 when supported in the deployed condition (see FIGS. 12-14). For example, the roof 390 and 391 may slope downwardly in an inboard direction toward the roof pivot joints (see FIGS. 31 and 32). Again, sloping of the roof 390 and 391 may permit the roof to shed water, snow, dirt, and/or foreign objects. Each sloped roof 390 and 391 may also be positioned to provide enhanced protection of livestock (such as cattle or horses), people, or other items within and/or adjacent the covered area 384.

Each roof 390 and 391 may be driven by respective hydraulic cylinders 396 and 398 between folded and unfolded positions. Hydraulic cylinders 396 may be operably attached to the wheeled chassis 304 and the corresponding roof 390 and located adjacent to respective ends of the wheeled chassis 304. For instance, hydraulic cylinders 396 may each be pivotally attached to the frame 312 and to the roof 390 to cooperatively swing the roof 390 between the deployed and stored conditions. In the depicted embodiment, the piston 402 of the hydraulic cylinder 396 may be selectively retracted to fold the roof 390 and extended to unfold the roof 390.

Similarly, hydraulic cylinders 398 may be operably attached to the wheeled chassis 304 and the corresponding roof 391 and located adjacent to respective ends of the wheeled chassis 304. For instance, hydraulic cylinders 398 may each be pivotally attached to the frame 312 and to the roof 391 to swing the roof 391 between the deployed and stored conditions. As with hydraulic cylinder 396, the piston 402 of the hydraulic cylinder 398 may be selectively retracted to fold the roof 391 and extended to unfold the roof 391.

Each shelter 310 and 311 may be erected by unfolding the corresponding roof 390 and 391 away from the folded location alongside the corresponding panels 308. Each roof 390 and 391 may be unfolded and raised relative to the wheeled chassis 204 so that the roof 390 and 391 extends outboard relative to the spine 316. For example, the hydraulic cylinders 396 and 398 may be extended to unfold and raise the corresponding roof 390 and 391. With the roof 390 and 391 extended, respective brackets 386 and 388 may be unfolded relative to the wheeled chassis 304 into the deployed condition so as to extend transversely relative to the spine 316. The gussets 392 and 393 may also be secured between the wheeled chassis 304 and the corresponding roof 390 and 391 to support each roof 390 and 391.

To return the shelter 310 and 311 from the deployed condition to the stored condition, each roof 390 and 391 may be lowered to the folded position so that the shelter 310 and 311 is stored. In the depicted embodiment, respective brackets 386 and 388 may first be folded into the stored condition. Each gusset 392 and 393 may also be detached from the corresponding roof 390 and 391, the frame 312, or both to permit roof movement. With the gussets 392 and 393 and the brackets 386 and 388 stored, each roof 390 and 391 may be folded and lowered so that the roof 390 and 391 is outboard of the respective panels 308 in the stored condition. For example, the hydraulic cylinders 396 and 398 may be retracted to fold and lower the corresponding roof 390 and 391.

Additional advantages of the various embodiments of the invention will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments, but is not necessarily included. Thus, the present invention encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

The disclosure claimed is:

1. A portable windbreak configured to be operably attached to a vehicle for advancement in a forward direction, said portable windbreak comprising:
a wheeled chassis including an elongated frame and a ground-engaging transport wheel operable to support the frame above ground, with the frame extending longitudinally along the forward direction to at least partly define a storage area; and
a set of panels removably supported by the frame and extending longitudinally along the frame in a stored condition, with the frame configured to support the set of panels in the stored condition while the portable windbreak is advanced in the forward direction by the vehicle,
said set of panels being shiftable between the stored condition, in which said set of panels is supported within the storage area by the wheeled chassis for transport therewith, and a deployed condition, in which one or more panels of the set extend outside of the storage area to form a windbreak wall.

2. The portable windbreak as claimed in claim 1,
each of said panels of the set including a panel frame and a panel brace shiftably attached relative to the panel frame,
each of said panel braces being shiftable into and out of a deployed position in which the panel brace extends downwardly from the respective panel frame to engage the ground.

3. The portable windbreak as claimed in claim 2,
each of said panel braces including an arm and a pivot assembly attached relative to the arm,
said pivot assembly including a sleeve rotatably mounted relative to the panel frame for rotation of the panel brace about an upright axis.

4. The portable windbreak as claimed in claim 3,
said pivot assembly including a flange fixed adjacent a proximal end of the arm,
said sleeve including a tab pivotally attached to the flange at an arm pivot joint, with the arm pivot joint permitting the arm to swing relative to the panel frame about a lateral axis.

5. The portable windbreak as claimed in claim 3, each of said panel braces including a stake element configured to be driven into the ground.

6. The portable windbreak as claimed in claim 5, further comprising:
a spiral ground anchor attached relative to a respective panel brace and configured to be driven into the ground.

7. The portable windbreak as claimed in claim 6, further comprising:
an elongated chain removably attached to the spiral ground anchor and the respective panel brace to restrict the respective panel brace from being shifted out of the ground.

8. The portable windbreak as claimed in claim 2, each of said panels of the set including a wheeled panel with the panel frame and a pair of panel wheels, said pair of panel wheels configured to support the panel frame above ground and roll across the ground to permit swinging movement of the wheeled panel.

9. The portable windbreak as claimed in claim 8, each of said panel braces being attached to the panel frame adjacent a respective pair of panel wheels, with the panel brace configured to engage the ground in the deployed position to restrict swinging movement of the wheeled panel.

10. The portable windbreak as claimed in claim 8, said panel frame defining an upright panel axis,
said panel wheels each defining a panel wheel axis, with the panel wheels being axially offset from the upright panel axis to opposite sides of the respective panel axis.

11. The portable windbreak as claimed in claim 10,
said wheeled panel including wheel brackets that depend from the panel frame to rotatably support respective panel wheels, with the wheel brackets cooperatively defining an oblique angle therebetween.

12. The portable windbreak as claimed in claim 1,
each of said panels of the set including a panel frame, an upper sheet, and a lower sheet, said upper and lower sheets of each panel being fixed relative to the panel frame to restrict wind flow through the panel, with the upper and lower sheets being spaced apart to cooperatively define a relief opening that permits wind to pass between the upper and lower sheets.

13. The portable windbreak as claimed in claim 1, further comprising:
a shelter supported relative to the wheeled chassis, with the set of panels and the shelter being shiftable between a deployed condition and a stored condition for transport.

14. The portable windbreak as claimed in claim 13,
said shelter including a roof shiftably attached relative to the wheeled chassis and extending laterally outboard relative to the wheeled chassis in the deployed condition.

15. The portable windbreak as claimed in claim 14,
said shelter including a hydraulic cylinder to drive the roof between the deployed condition and the stored condition.

16. The portable windbreak as claimed in claim 14,
said shelter including a roof bracket that removably interconnects the roof and the wheeled chassis to support the roof in the deployed condition.

17. The portable windbreak as claimed in claim 14,
said roof extending downwardly relative to the wheeled chassis in the stored condition.

18. The portable windbreak as claimed in claim 17,
said roof being located outboard of the set of panels when the set of panels and the roof are in the stored condition.

19. The portable windbreak as claimed in claim 18,
said frame including a spine extending longitudinally along the forward direction and at least partly defining a storage area to receive the set of panels in the stored condition so that the set of panels are removably positioned between the spine and the roof.

20. The portable windbreak as claimed in claim 19,
each of said panels of the set including a wheeled panel with the panel frame and a pair of panel wheels,
said pair of panel wheels configured to support the panel frame above ground and roll across the ground to permit swinging movement of the wheeled panel into and out of the storage area.
